(19) United States
(12) Patent Application Publication
(10) Pub. No.: US 2002/0161757 A1
(43) Pub. Date: Oct. 31, 2002

(54) Simultaneous searching across multiple data sets

(76) Inventors: Jeffrey Mock, Rosemead, CA (US); Brian Hauer, El Segundo, CA (US); Anthony S. Karrer, El Segundo, CA (US); Michael Ester, Culver City, CA (US); Ryan Chute, La Verne, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/811,150

(22) Filed: Mar. 16, 2001

(51) Int. Cl. G06F 7/00

(52) U.S. Cl. 707/5

(57) ABSTRACT

A method and apparatus for indexing, searching, and retrieving data from data sets. Data sets may reside in the same database or be distributed across different databases. Data sets, whether within the same or distributed databases, may have the same format or heterogeneous formats. Source data sets are represented with mapping tables and inverted or index tables. Native fields of databases described in source tables are mapped to international or specialized standards. Source data fields that map to the standard field searched upon are identified, and objects satisfying a query's request are identified based upon the standard fields searched. Values are retrieved from the identified objects.

### BACKGROUND OF THE INVENTION

1. Field of the Invention

This invention relates in general to computer-implemented database systems, and, in particular, to techniques related to indexing, search, and retrieving object data.

2. Description of Related Art

Databases are computerized information storage and retrieval systems. Data may be stored, searched, and retrieved using various systems. For example, the most widely used technology for managing data, particularly structured data, is a relational database. Relational databases have been the main technology for representing data through a series of structured relationships.

Relational databases use relational techniques for storing and retrieving data. Relational databases are organized into tables including rows and columns of data. The rows are formally called tuples. A database will typically have many tables and each table will typically have multiple tuples and multiple columns. The tables are typically stored on random access storage devices (RASD) such as magnetic drives for semi-permanent storage.

Relational databases are often part of a Relational Database Management System (RDBMS). A RDBMS may be based on the Structured Query Language (SQL) interface that is well known in the art. The SQL interface has evolved into a standard language for relational database software and has been adopted as such by both the American National Standards Institute (ANSI) and the International Standards Organization (ISO). The SQL interface allows users to formulate relational operations on the tables either interactively, in batch files, or embedded in host languages, such as C and Java in a standardized manner. SQL also allows the user to manipulate the data. The definitions for SQL provide that the RDBMS should respond to a particular query with a particular set of data given a specified content.

Relational databases may be accessed through various systems. These systems may be local or remote such as, for example, the Internet. The Internet is a collection of computers and computer networks that exchange information via Transmission Control Protocol/Internet Protocol (ATCP/IP). Currently, the use of the Internet computer network for commercial and non-commercial uses is exploding. Via its networks, the Internet enables many users in different locations to access information stored in data sources (e.g., databases) stored in different locations.

The World Wide Web (i.e., the “WWW” or the “Web”) is a hypertext information and communication system used on the Internet computer network with data communications operating according to a client/server model. Typically, a Web client computer will request data stored in data sources from a Web server computer, at which Web server software resides. The Web server software interacts with an interface connected to, for example, a Database Management System (“DBMS”), which is connected to the data sources. These computer programs residing at the Web server computer will retrieve the data and transmit the data to the client computer. The data can be any type of information, including database data, static data, HTML data, or dynamically generated data. Databases on the Web are often used to store various types of information including text and images.

One important aspect of managing a relational database and enabling access and search capabilities through, for example, the Internet, is being able to organize or index, search, and retrieve desired data in an efficient manner. These functions are complicated when the databases are distributed, i.e., spread over more than one server or database system. Indexing, searching, and retrieving are also complicated when the databases are heterogeneous or include different data formats. Further difficulties result when data is organized with different descriptive fields such that searching for one field in one database may be represented by another field for the same type of data in another database. Additionally, the ability to search databases simultaneously is compromised as a result of these complications.

Conventional systems have attempted to overcome these obstacles with different techniques, all of which fail to adequately address the problems. For example, conventional systems rely on customization to support different relational schemas. In customization, a unique adaptation is created for searching sets of tables and relationships instituted by a specific design. Thus, with customization, searches may be performed on multiple databases with different formats. However, since each adaptation is unique, customization is very expensive and time consuming. Further, customized software may not be portable - software adapted to one system may have be reconfigured, i.e., further customized, to be adapted to a different system.

Conventional systems have also attempted to search multiple heterogeneous data sets using simplification techniques that reduce and reconcile multi-database data into a common subset of descriptive fields. This technique simplifies the software and data content. However, these advantages are at the expense of having to describe data in more simple terms. As a result, a larger number of more descriptive relationships and fields may not be utilized for searches, and search capabilities are limited. At the extreme of simplification, data representation reduces to keyword and free text content, which there is little or no data structure. Related but very different technologies for storing, analyzing, and searching text have been developed in the industry, and their application has been especially prevalent on the Web in the form of text “search engines”. These technologies depend largely on the semantic content of text sources to identify, compare, determine similarity between entities such as Web pages and Web sites.

Another approach of conventional systems is to utilize consolidation techniques. With consolidation, heterogeneous information resources are migrated to the design of a dominant source. Thus, the format of multiple data sources may assume the dominant data structure, however, the same shortcomings described above with respect to simplification also exist with respect to consolidation. For example, meta-data standards mapping may be implemented in attempt to achieve a consistent base of search criteria. These standards may be national or international. One example standard is the Dublin Core used to document resources on the Internet. Other examples of standards, using library and art-related content as a sample topic, include Computer Interchange of Museum Information (CIMI), Categories for the Description of Works of Art, MARC (for library sources), and VRA Core (for visual arts). These standards, whether for Internet classification, artistic works classification, or for various other topics, may be utilized to map individual information sources into particular data formats or data classifications. Typically, these schemas describe higher level categories or classifications that frame the types of information that should be recorded under different descriptive headings. However, these various meta-data standards do not provide for cataloging and implementation solutions.

The shortcomings of conventional systems are further amplified as the size of the information sources increase. In addition, the previously described shortcomings are also amplified as the number of information sources increase. In these instances, information relationships, tables and fields become more complex and more difficult to index and search. As a result, conventional systems cannot implement simultaneous searches across multiple, heterogeneous data sets.

While the above shortcomings and the present invention are most clearly described in terms of the formalisms of RDBMS, the same problems and the present invention apply to other modes of expressing structured data, specifically Standard Generalized Markup Language (SGML) and the more industry accepted, Extensible Markup Language (XML). Accordingly, there is a need in the art for a technique that provides users a consistent framework for performing simultaneous searches across multiple, heterogeneous data sets that is both time and cost efficient, and that does not shoehorn data into a format in which it was not originally intended.

### SUMMARY OF THE INVENTION

To overcome the limitations in the prior art described above, and to overcome other limitations that will become apparent upon reading and understanding the present specification, the present invention discloses a method, apparatus, and article of manufacture for indexing, searching, and retrieving data in a database.

In accordance with the present invention, source data tables are represented with mapping tables and inverted or index tables generated based on the mapping tables. The source data tables may reside on the same database in the same data store or distributed across different systems. Native fields of databases described by source tables are mapped to international or specialized standards. In response to a query, native collection fields that may be mapped to standard fields that are searched, and objects are identified that satisfy the query's request for a particular object or set of data such as a table. Once the relevant object is identified, values matching the search criteria are retrieved, formatted, and displayed.

### BRIEF DESCRIPTION OF THE DRAWINGS

Referring now to the drawings in which like reference numbers represent corresponding parts throughout:

FIG. 1 is a schematic illustrating a hardware environment in one embodiment of the present invention, and more particularly, illustrates a typical distributed database system;

FIG. 2A is a flow diagram illustrating processing performed by a data management system and associated tables;

FIG. 2B is a flow diagram illustrating further processing performed by a data management system;

FIG. 3 is an illustrative example source tables related to objects;

FIG. 4 is an illustration including examples of source tables related to artists and associated objects;

FIG. 5 is an illustration including examples of source tables related to geographic locations and associated parent/child relationships;

FIG. 6 is an illustration including examples of source tables related to events and associated people, objects, locations, and dates;

FIG. 7 is an illustration of generated mapping tables related to collections of data and relationships of data within that collection;

FIG. 8 is an illustration of generated mapping tables related to fields and field groups;

FIG. 9 is an illustration of a generated mapping table related to join operations;

FIG. 10 is an illustration of generated mapping tables joined together;

FIG. 11 is an illustration of join operations;

FIG. 12 is an illustration of generated inverted or index tables relating to terms and associated objects;

FIG. 13 is an illustration of further generated inverted or index tables relating to terms and associated objects;

FIG. 14 is an illustration of generated inverted or index tables relating to values and associated objects;

FIG. 15 is an illustration of tables relating to standard field mapping tables;

FIG. 16 is an illustration of example tables used to identify objects and retrieve data from the identified objects; and

FIGS. 17A-B are illustrations relating to an example search with the data processing system and related source, mapping tables, and inverted or index tables.

### DETAILED DESCRIPTION

In the following description of embodiments of the invention, reference is made to the accompanying drawings which form a part hereof, and which is shown by way of illustration specific embodiments in which the invention may be practiced. It is to be understood that other embodiments may be utilized as structural changes may be made without departing from the scope of the present invention.

### Hardware Architecture

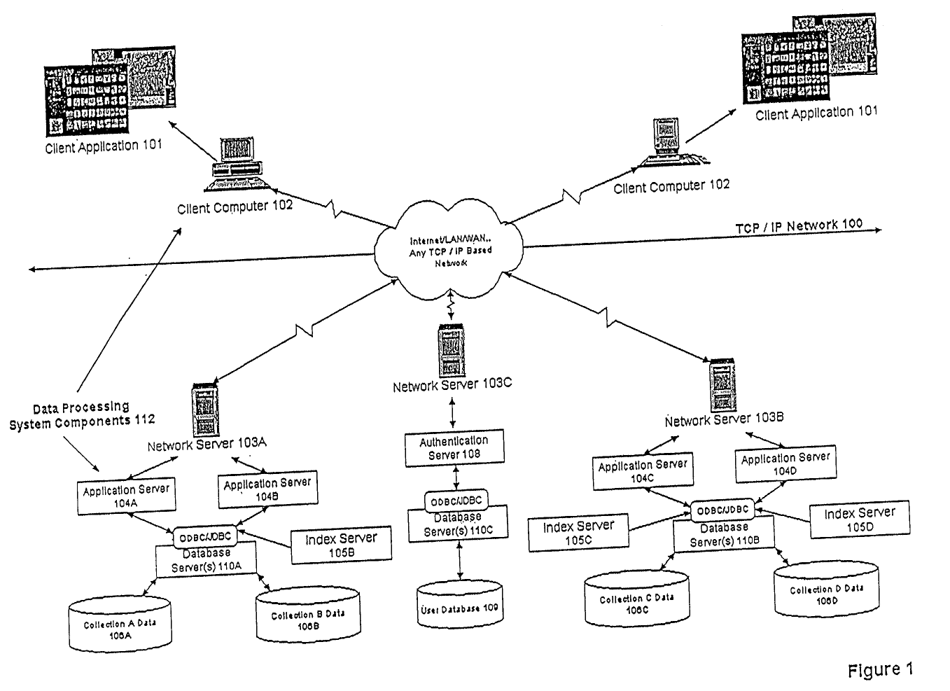

FIG. 1 is a schematic that illustrates the hardware environment of an embodiment of the present invention. More particularly, the figure illustrates a typical distributed computer system using a network 100 to connect client computers 102 executing client applications 101 to network servers 103A, 103B, 103C (collectively referred to as 103) executing server software and other computer programs. Network servers are connected to application servers 104A, 104B, 104C, and 104D (collectively referred to as 104). Data stores 106A, 106B, 106C, and 106D (collectively referred to as 106) of database servers 110A, 110B (collectively referred to as 110) may store various collections of data or data sets or data collections 106. Database servers 110 are accessed if authentication server 108 (only one illustrated) grants the appropriate privileges. Data stores 106 may store various types of data sets or collections of data, such as documents, structured data, databases, or related tables within a database such as, for example, in a relational database. One embodiment of the present invention provides a data processing system 112. The data processing system 112 components reside on a network server and facilitate the indexing, searching, and retrieval of data from data sources 106 using client computers 102 and network servers 103.

A typical combination of resources may include a client computer 102 that is a personal computer or workstation, and a network server 103 that is a personal computer, workstation, minicomputer, or mainframe, and an authentication server that is a personal computer, workstation, minicomputer, or mainframe. These systems are coupled to one another by various networks, including, but not limited to, LANs, WANs, SNA networks, and the Internet. The client computer 102, network server 103, and authentication servers 108 additionally comprise an operating system and one or more computer programs.

A client computer 102 typically executes a client application 101. Client computer application 101 may be a computer program such as a browser. Whether client computer 102 can access network server 103 and the related data stores 106 is determined by privileges granted by the authentication servers 108. In one embodiment of the present invention, there is a separate authentication server 108 for each database or data store 106. Thus, an authentication server 108 grants privileges to database 106A, a different authentication server 108 grants privileges to database 106B, and so on. In an alternative embodiment, any number of authentication servers 108, including a single authentication server 108, may control privileges for all data stores 106.

Network server 103 executes one or more server software programs. Network server 103 also uses a data source interface and, possibly, other computer programs, for connecting to the data stores 106. The client computer 102 is bi-directionally coupled with one or more authentication servers 108 over network 100 such as a line or via a wireless system. In turn, the authentication servers 108 are bi-directionally coupled with network servers 103 which are in turn bi-directionally coupled with databases or data stores 106. Data stores 106 may reside on the same database server 110, on different database servers 110 of the same system, or on different database servers 110 of different systems. For example, databases may be stored on geographically distributed data stores 106.

An embodiment of the present invention provides a data processing system 112 embodied in client computer 102 and application server 104. Data processing system 112 may be executed between the client and network server computers 102 and 103. More specifically, queries from client computers 102 may request data from one or more databases within one or more data stores 106. With proper privileges granted by the authentication servers 108, the data processing system 112 may be utilized to facilitate the searching and retrieval of data from one or more data sets of one or more data stores 106 in response to queries.

Generally, the operating system and computer programs that implement the data processing system 112 are tangibly embodied in and/or readable from a device, carrier, or media, such as memory, other data storage devices, and/or data communications devices. Under control of the operating system, the computer programs may be loaded from memory, other data storage devices and/or data communications devices into the memory of the computer for use during actual operations. Thus, the present invention may be implemented as a method, apparatus, or system. Of course, those skilled in the art will recognize that many modifications may be made to this configuration without departing from the scope of the present invention.

Those skilled in the art will recognize that the exemplary environment illustrated in FIG. 1 is not intended to limit the present invention. Indeed, those skilled in the art will recognize that other alternative hardware environments may be used without departing from the scope of the present invention.

### Simultaneous Searching Across Multiple Data Sets

An embodiment of the present invention provides a data processing system 112 that executes in conjunction with a database system such as, for example, a Relational Database Management System (RDBMS), to enable simultaneous searching across multiple, heterogeneous data sets. Those skilled in the art will appreciate that the present invention may be applied to source tables assuming other structured formats such as, for example, documents in SGML or XML. However, for purposes of simplicity and understanding, this specification describes the data processing system 112 with reference to relational source data tables related to works of art. Indeed, those skilled in the art will recognize that the present invention may be applied to other data systems.

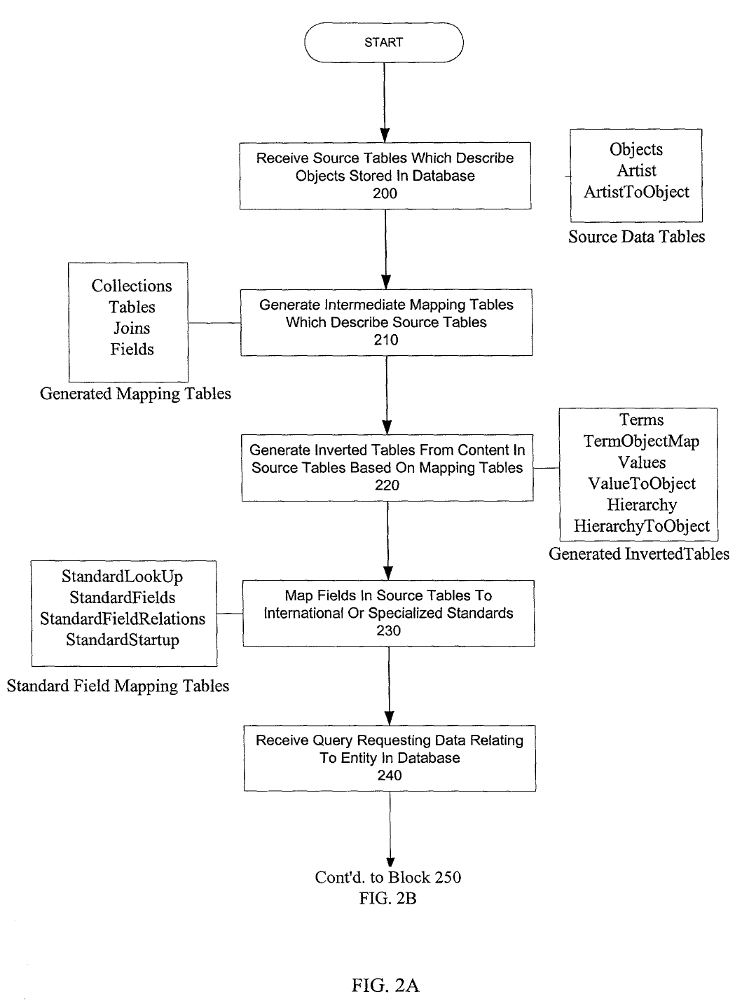

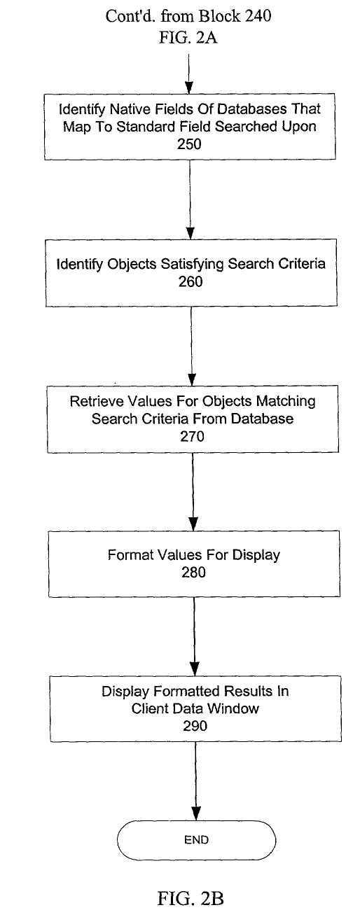

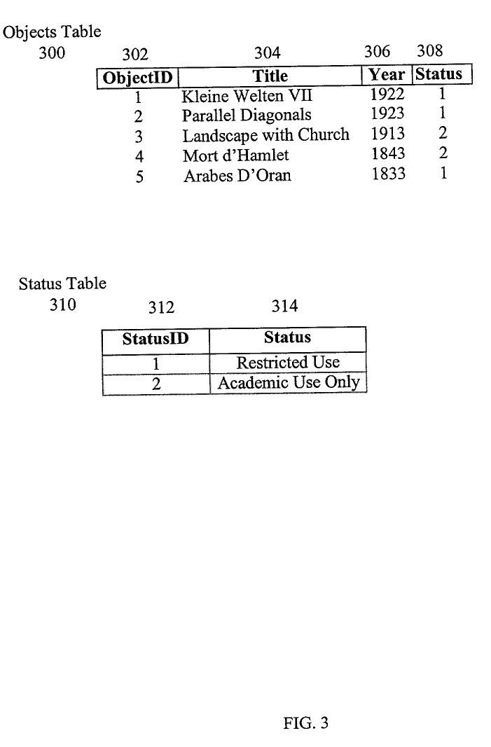

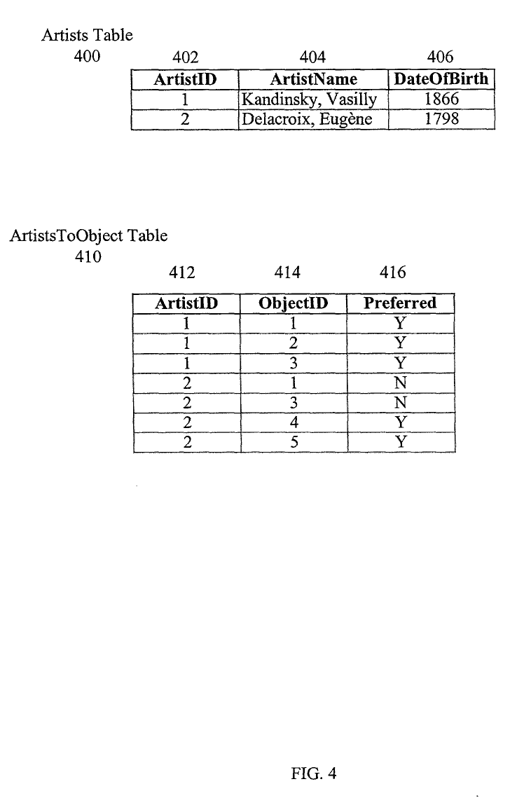

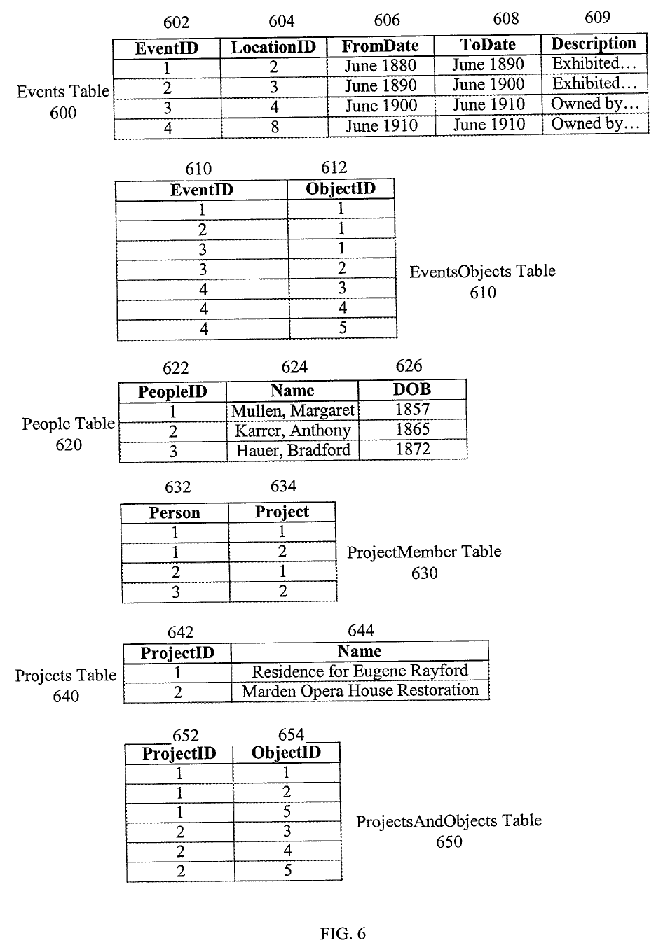

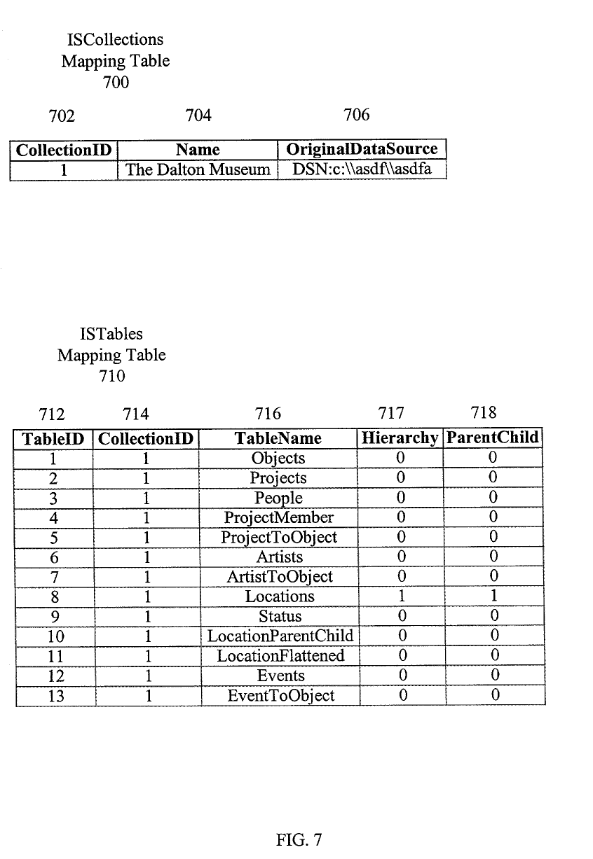

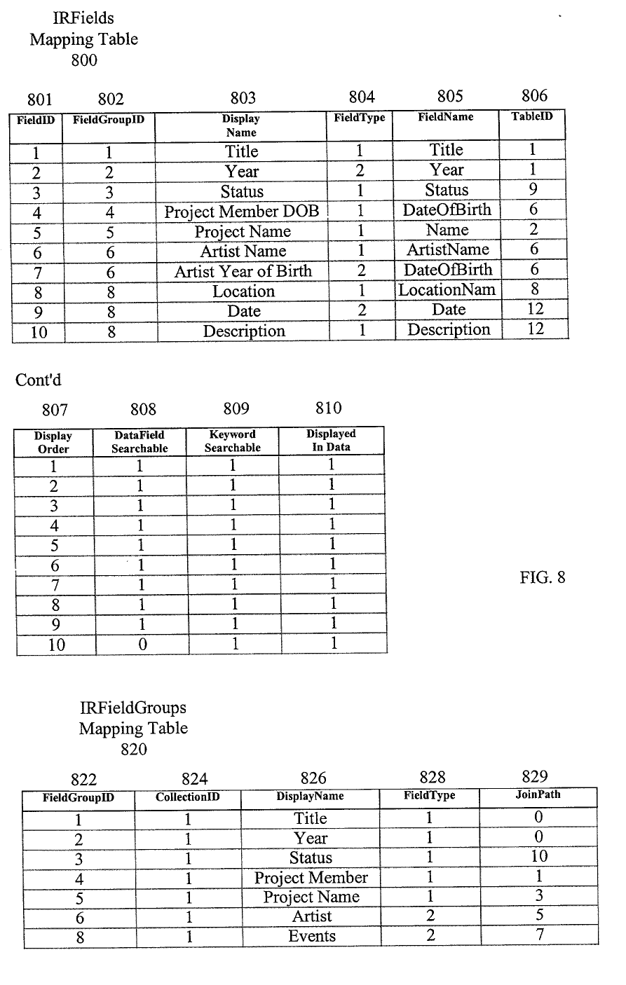

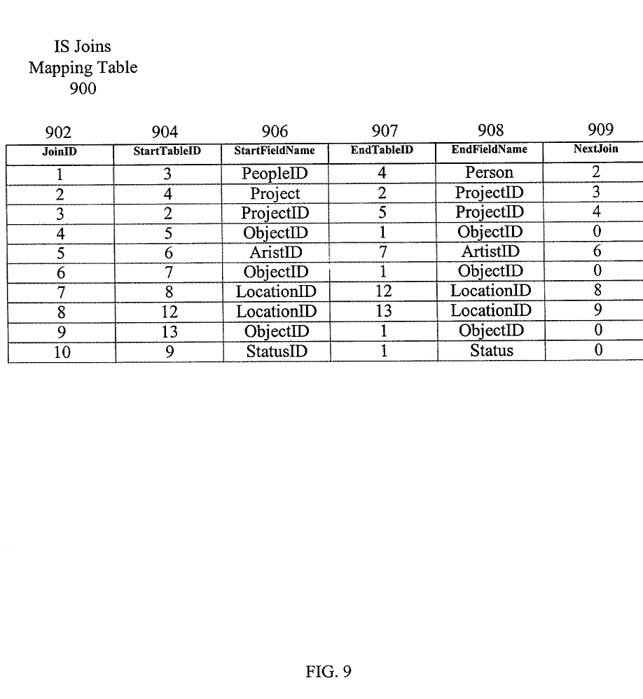

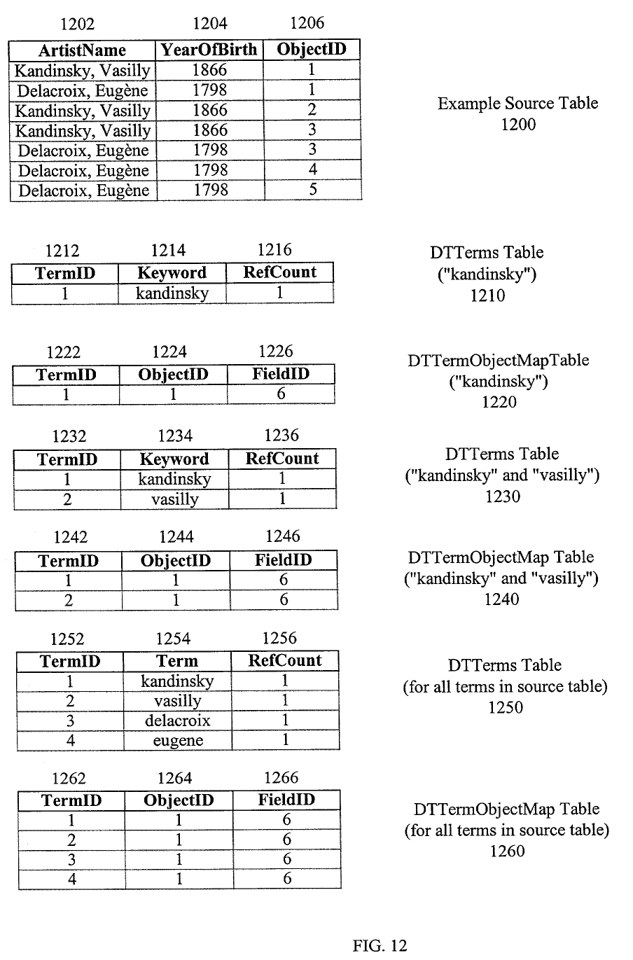

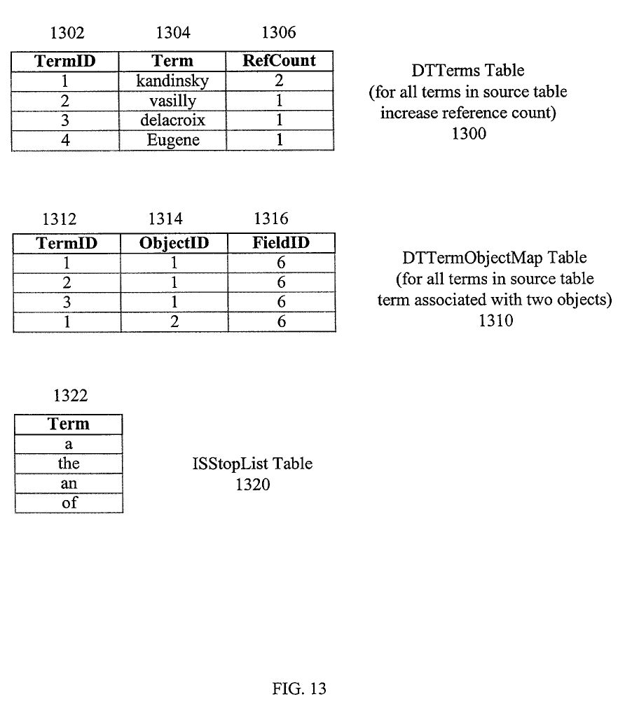

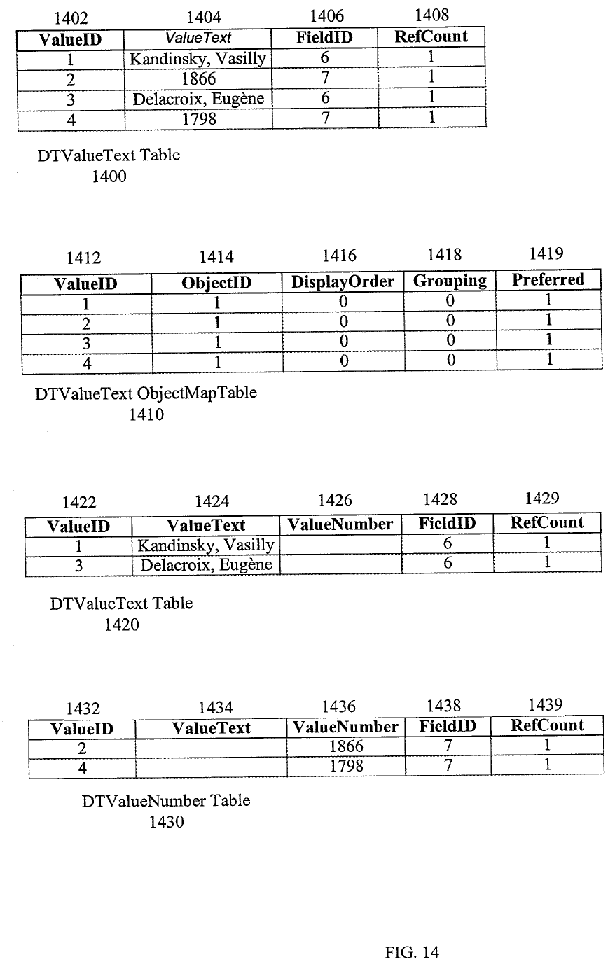

Data searching and retrieval across heterogeneous data sets with the data processing system 112 may be accomplished as illustrated in FIGS. 2A-B. FIGS. 2A-B are flow diagrams illustrating tasks performed by the data management system 112 and example tables (explained in further detail in this specification) that may be associated with each task. In block 200, source tables (as discussed below in FIGS. 3-6) are received by the data processing system 112. Intermediate mapping tables (as discussed in FIGS. 7-11), in block 210, define the relations of the source tables. The system's administrator configures mapping tables during the initial installation process. Once the relations and field properties of the source tables are described, the inverted index tables may be populated. In block 220, the data processing system 112 generates inverted tables (as discussed below in FIGS. 12-14) from the content in the source tables based on the intermediate mapping tables. In block 230, the fields in the source tables are mapped to international or specialized metadata standards. In block 240, the data processing system 112 receives a query requesting data relating to one or more entities in one or more databases. An “entity” may be an object itself or one or more tables with data. However, for simplicity, this specification will refer to objects, however, those skilled in the art will recognize that a query may request an object, tables, or data in other formats.

Objects satisfying the query's requests are identified by the data processing system 112 in block 240. Descriptive values pertaining to the queried entity are then organized into descriptive data sets for different field classifications in block 250. The data processing system 112 maps the database fields to metadata standards utilizing the generated mapping standards. In block 260, the data processing system 112 identifies objects satisfying the search criteria. In block 270, the data processing system 112 retrieves the query results from the database. Then, in block 280, the data processing system 112 formats the results based on administrator and user configurations. Finally in block 290, the data processing system 112 displays the query results. Each of these tasks will be described in further detail with reference to an example set of source data tables and related mapping and inverted or index tables.

Source Data Tables

Beginning with block 200, the data processing system 112 receives source data table(s) from, for example, a relational database. Within a source relational database, the schema of the database may be as simple as a single flat table of fields and values, or have any multi-relation model resulting in a complex set of related tables. For purposes of illustration, source tables used in this particular example relate to various attributes and relationships of art (e.g., artist name, title of work, etc.). However, these source tables are mere examples, and databases and tables relating to other subjects such as automobiles (e.g., parts, dealerships, mechanics), business (shipping orders, source, destination, cost, price, customer, customer address, etc.), medicine (doctor, patient, prescription, age, condition), etc. may also be processed by the data processing system 112.

Examples of source tables related to works of art are illustrated in FIGS. 3-6. The Objects table 300 describes different objects or works of art. The Objects table 300 includes columns ObjectID 302, Title 304, Year 306, and Status 308. An ObjectID 302 is a unique identifier which identifies a specific object, or in this case, a particular work of art. In one embodiment of the present invention, an ObjectID 302 is a unique numeric value (e.g., 1, 2, 3, etc.). Those skilled in the art will recognize, however, that other unique identifiers may similarly be used such as unique alpha, alphanumeric, symbol, and keyword identifiers may also be utilized. Each object is also associated with a corresponding Title 304, Year 306, and Status 308 through the ObjectID 302. For example, the object associated with ObjectID=3 relates to a work of art entitled “Landscape with Church,” created in 1913 with a “1” status.

The Status table 310 indicates the status of a work, as indicated in the Status column 308 of the Objects table 300. Entries in the Status 310 table are allocated a StatusID 312. The StatusID 312, similar to ObjectID 302, is a unique identifier that associates a status of an object with a unique value. For example, a Status of “1” represents a restricted work, whereas a Status of “2” represents a work for “academic use only.” Thus, for example, “Parallel Diagonals” is a restricted work whereas ““Landscape with Church” is for academic use only.

Another example of a source data table is Artists table 400. Artists table 400 includes columns ArtistID 402, ArtistName 404, and DateOfBirth 406. Artist ID 402 is a unique identifier that associates a unique value with an artist. For example, ArtistID=1 is associated with ArtistName=Vasilly Kandinsky, born in 1866.

The ArtistToObject table 410 is an instance table based on the supporting Artists table 400. The ArtistToObject table 410 also utilizes an Artist ID 412. The ArtistToObject table 410 links each Artist, as identified by ArtistID 402, with an object, as identified by Object ID 414 within the Objects table 300. In addition, the ArtistToObject table 410 provides the ability to allocate a preference with a Preferred value 416. If a work of art has more than one artist, but in response to a query, only one artist can be selected, then a Preferred value 416 can be used to indicate a single artist. For example, artists identified by Artist ID=1 and ArtistID=2 (i.e., Kandinsky and Delacroix, respectively) are both artists of “Landscape with Church” or ObjectID =3. In response to a query, if only one artist can be associated with an object, then ArtistID=1 or “Kandinsky, Vasilly” is considered the artist of this work since this ArtistID has a preferred status.

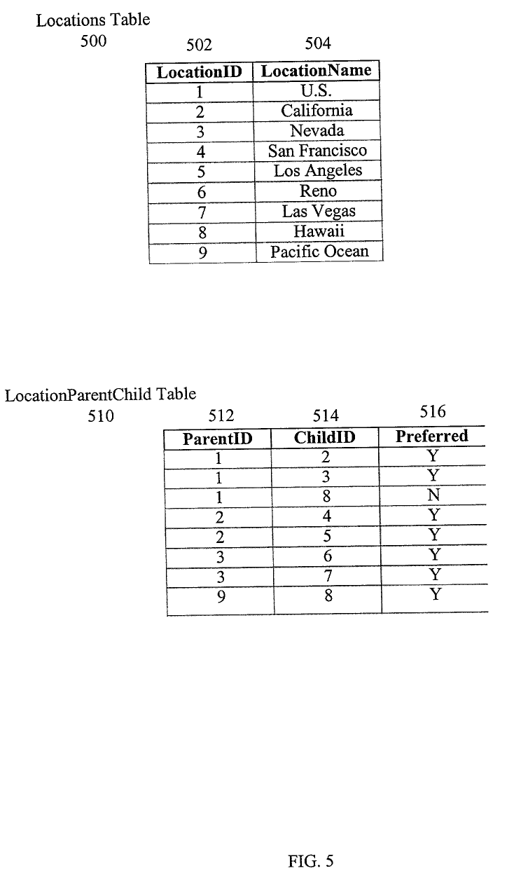

Additional examples of source tables that may be processed by the data processing system 112 are hierarchical tables. Examples of hierarchical tables are tables relating to geographical relationships. For example, with reference to FIG. 5, the Locations table 500 includes columns LocationID 502 and Location Name 504. LocationID 502 values are unique values associating a geographic location with a unique value. For example, for each unique LocationID (e.g., 1, 2, and 7) there is a respective geographic description or location (e.g., U.S., California, and Las Vegas).

The LocationParentChild table 510 illustrates the hierarchical or parent/child relationships within the Locations table 500. The LocationParentChild table 510 includes three columns: ParentID 512, ChildID 514, and Preferred 516. The ParentID 512 and ChildID 514 columns are populated with LocationID 502 values based on their parent-child relationships. For example, LocationID 502 values are also ParentID 512 values if the corresponding location is a parent of a child location. For example, both San Francisco (LocationID 4) and Los Angeles (LocationID=5) are cities in California (LocationID=2). In other words, California is a parent of both these cities. However, California is not a parent of Reno (LocationID=6) since Reno is in Nevada (LocationID=3). Thus, California (LocationID=2) is designated as parent of children San Francisco (LocationID=4) and Los Angeles (LocationID=5). Other similar relationships are also illustrated.

One location may be a parent of multiple child locations. For example, both California (LocationID=2) and U.S. (LocationID=1) are parents of Los Angeles (LocationID=5). In the event that only one parent can be designated, a Preferred value 516 can indicate which parent is designated. Continuing with the previous example, California is the preferred parent of both Los Angeles and San Francisco instead of U.S. Other similar relationships are illustrated in the LocationParentChild table 510.

Other source tables relating to the previously described tables may also be generated. For example, the Events table 600 outlines which art events occurred during a particular time period. The Events table 600 includes columns: EventID 602 to identify the event, LocationID 604 to identify the location with the Locations table 500, FromDate 606 and ToDate 608 to identify the time frame of the vent, and a Description 609 of the event.

An additional supporting table is the EventstoObject table 610. For instance, an event corresponding to EventID=1 is associated with the object associated with ObjectID=1. With reference to the Objects table 300 and Events table 600, the event corresponding to EventID=1 relates to an exhibition (Description=Exhibited . . . ) of the work Kleine Welten VII” (Object ID=1, with reference to the Objects table) in California (LocationID=2) from June 1880 (FromDate=June 1880) to June 1890 (ToDate=June 1890). Continuing with reference to the previously described tables, further relationships may be portrayed within the People table 620, ProjectMember table 630, Projects table 640, and ProjectsandObjects table 650.

The People table 620 includes columns: PeopleID 624, Name 626, and DOB 628. PeopleID 624 is a unique identifier for each person and links that identifier to the person's Name 626 and DateOfBirth (DOB) 628.

The ProjectMember table 630 includes columns Person 632 and Project 634. The ProjectMember table 630 associates a person, as identified by the People table 620 and through the Person column 632, with a particular Project 634.

The Projects table 640 includes columns ProjectID 642 and Name 644. The ProjectID 642 is a unique numeric identifier for a particular project Name 644. For example, the project with the name “Residence for Eugene Rayford” is allocated ProjectID=1.

Finally, the ProjectsAndObjects table 650 associates each project, as identified in the Projects table 640, with an object, as identified in the Objects table 300. Thus, for example, combining these relational tables, Anthony Karrer (People Table 620, PeopleID=2), born on 1865 (PeopleTable 620, DOB=1865), is associated with the project related to the Eugene Rayford residence (ProjectMember Table 630, Person=2, ProjectID=1) involving the work Kleine Welten VII (Objects table 300, ObjectID=1). Other relationships may be similarly represented.

The detailed description of these example source tables illustrates the potential complexity of structured data linking numerous data fields. As previously explained, the source tables describing objects may be very simple or may involve many levels of relationships. Indeed, those skilled in the art will recognize that various other relational schemas may be represented with numerous other topics or subject areas. Thus, these example source tables are merely illustrative of the large number of different topics and objects that may be represented.

Mapping Tables Based On Source Tables

Referring back to FIG. 2A, and continuing with block 210, mapping tables are configured during the initial installation process. Mapping tables based on the source tables. Mapping tables describe the source data tables and their relationships. Once the relations and field properties of source tables are described, the inverted index tables may be populated. Continuing with the example source tables in FIGS. 3-6, the mapping tables describe the relationships of data within these source tables. In one embodiment of the present invention, and based on the example source tables previously described, mapping tables are embodied in different categories of tables: Collections, Tables, Fields, FieldGroups, and Joins. These mapping tables are illustrated in FIGS. 7-11, and each mapping table will described in further detail with reference to the previously described source tables.

The ISColletions table 700 generally identifies which collection or database of works of art is to be utilized. The ISCollections table 700 includes columns: CollectionID 702, Name 704, and OriginalDataSource 706. CollectionID 702 is a unique numeric value that identifies a particular collection or database of works of art. For each unique value identifying a collection, and there is a corresponding collection Name 704 and location which stores the collection field, e.g., DSN:c:\\asdf\asdfa, within the OriginalDataSource column 706.

The second mapping table is the ISTables table 710. ISTables 710 references the previously described ISCollections table 700 and includes six columns: TableID 712, CollectionID 714, TableName 716, Hierarchy 717, and ParentChild 718. The fields of these columns describe some of the relationships of the previously described source tables. TableID 712 includes fields that are unique values identifying each source table. CollectionID 714, as previously explained, includes unique values identifying a particular collection. In this example, there is only one collection, the Dalton Museum collection, as provided in ISCollections 700. Thus, source table Artists is identified by TableID=6. The data in this table does not involve hierarchies with parent-child relationships, thus the zero entries in Hierarchy 717 and ParentChild 718. However, for those tables which do involve hierarchies, such as the Locations table (TableID=8), the field for entry of the Hierarchy column 717 has a “1” entry. Likewise, since the Locations table involves parent-child relationships, this entry in the ParentChild column 718 is a “1.” The next mapping table is the IRFields table 800. IRFields 800 includes columns: FieldID 801, FieldGroupID 802, DisplayName 803, FieldType 804, FieldName 805, TableID 806, DisplayOrder 807, DataFieldSearchable 808, KeywordSearchable 809, and DisplayedinData 810. In addition, IRFields may also include additional columns not shown: JoinPath, Delimter, Hierarchy, HierarchyID. Similar to the other identification fields, FieldID 801 contains a unique value to identify a particular field. Groups of fields may be represented as a FieldGroup, represented by FieldGroupID 802, as explained further below with respect to the IRFieldGroups table.

Each field identified by FieldID 801 has a FieldName 805 and is of a FieldType 804. In this table, field entries may be string characters as indicated by FieldType=1 or numeric as indicated by a FieldType=2. For example, the field represented by FieldID=7 has a FieldName 805 “DateOfBirth” and is a numeric values as indicated by FieldType=2. In addition, TableID 806 indicates to which table a field belongs. In the event that a different name is used to display a field rather than the FieldName 805, a different name, DisplayName 803, can be used. For example, FieldName 805 “DateOfBirth” is actually displayed with DisplayName 803 “Artist Year of Birth.” Additionally, IRFields 800 also contains the Join Path, Hiearchy, and HiearchyID, which determine query join operations and hierarchical relationships, respectively. Joins and hierarchies are discussed later in this specification.

As previously explained, intermediate mapping tables are configured by, for example, a system administrator. Mapping tables define the relations and field properties of the source tables are described. Continuing with the previous example, the field with FieldName 805 “DateOfBirth” is associated with the table identified with TableID=6. Referring back ISTables 710, TableID=6 corresponds to the table “Artists.” Additionally, for each field, users may indicate order, search, and display criteria with corresponding Display Order 807, DataFieldSearchable 808, KeywordSearchable 809, and DisplayedInData 810 fields. For example, in this particular arrangement, the listed fields would be displayed in sequential order (1, 2, . . . 10). However, other display orders may be implemented. With regard to the other search and display criteria, whether these options are enabled is indicated by “0” and “1” values.

An additional mapping table is the IRFieldGroups table 820. As previously explained, individual fields may be grouped together in a field group. The field group may include fields that are related in some manner. For example, with reference to IRFields 800, fields identified by FieldID=8, FieldID=9, and FieldID=10 are included in the field group identified by FieldGroupID=8. More specifically, the FieldNames 805 “LocationName,” “Date,” and “Description” are all related to the “Events” field group. Each field group is associated with a CollectionID 822, DisplayName 824, and FieldType 826. For example, FieldGroup=8 is associated with the Dalton Museum Collection (Collection ID=1 from IS Collections table 700). This field group has a DisplayName 826 “Events” since these fields involve events related to the Dalton Museum. Further, a Field Type 828 for each field group is designated as a string (FieldType=1) or numeric value (FieldType=2).

The final example mapping table is the ISJoins table 900. ISJoins 900 outlines the required join operations and the involved tables and fields to obtain the requested data by processing tables to eventually identify a relevant object. A join operation is typically part of a SELECT SQL query and matches records in two tables. The two tables must be joined by at least one common field. In this example, ISJoins 900 includes columns: JoinID 902, StartTableID 904, StartFieldName 906, EndTableID 907, EndFieldName 908, and NextJoin 909. ISJoins 900 specifies how to join other tables (e.g., tables within ISTables) together to obtain requested values. For example, ISJoins 900 lists 10 join operations, each of which is identified with a unique value or JoinID 902. Each join operation is applied to a start field identified by StartFieldName 906 within a start table identified by StartTableID 904 and to an end field identified by EndFieldName 908 within an end table identified by EndTableID 907. The join operation identified by JoinID=5 begins with the Artist ID field (StartFieldName 906 corresponding to JoinID=5 of ISJoins 900) of the Artists table (TableID=6 of ISTables 710). This join operation ends with the ArtistID field (EndFieldName 908 corresponding to JoinID=5 of ISJoins 900) of the ArtistToObject table (TableID=7 of ISTables 710). The results of this join operation, however, do not result in the desired object. Rather, further join operations are required as indicated in NextJoin 909 which indicates a value of “6.” The association with the desired object is achieved when NextJoin=0. Thus, in order to obtain the desired object, the data processing system 112 proceeds to the next join operation identified by JoinID=6. After performing that join operation, however, the requested object is obtained, and no further join operations are necessary as indicated by the NextJoin=0. Specific examples of join operations are described in further detail below.

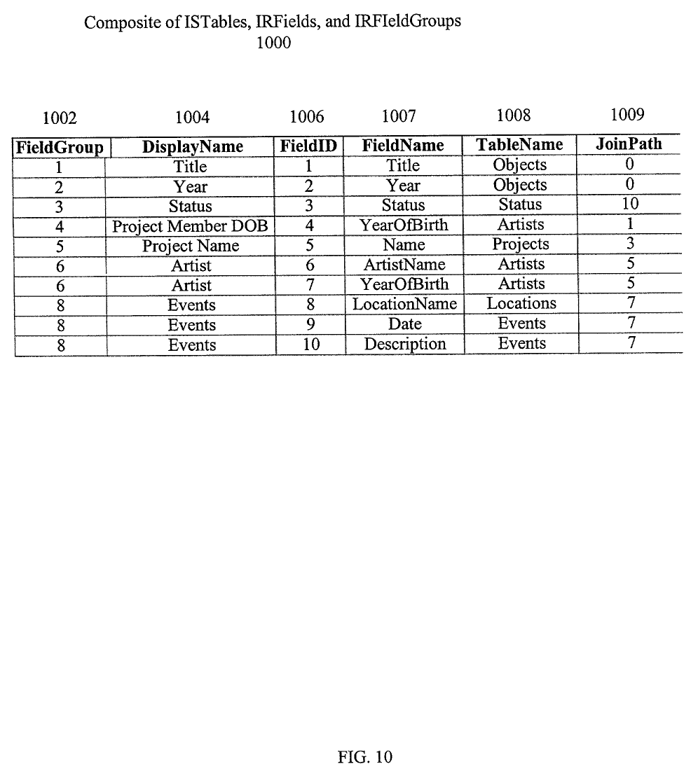

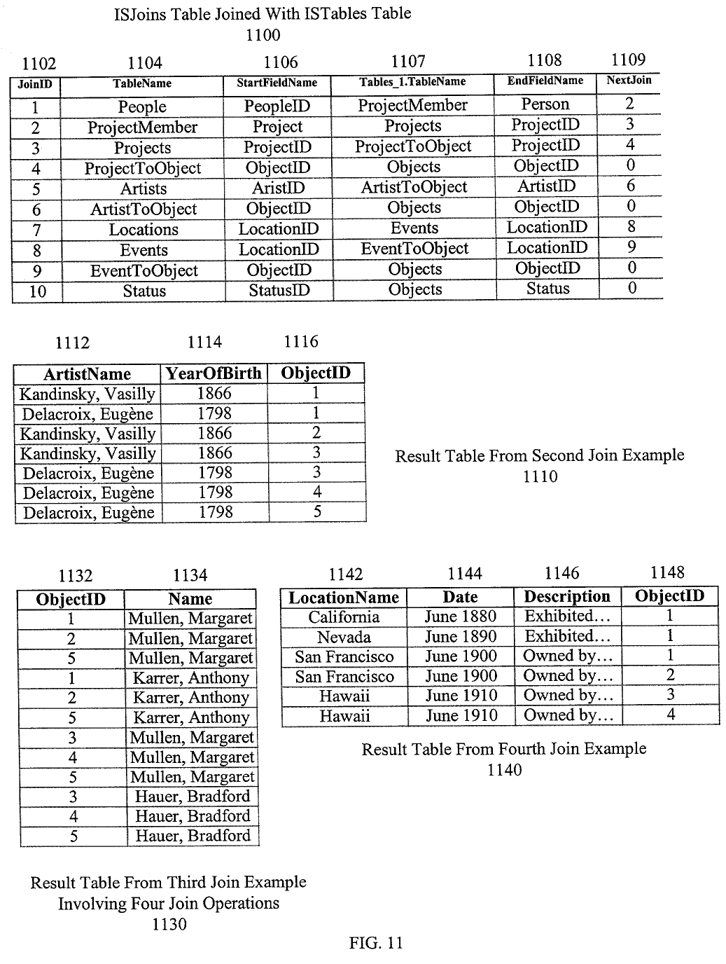

Thus, requested objects are obtained by performing join operations. In one embodiment of the present invention, reverse lookup tables are created to relate field values and terms back to objects. To do so, join tables map each field value to an object. In order to index values relating to an entity (e.g., an object or table) for the reverse index, the data processing system 112 traverses a series of join operations from the base table onto the core source data table. The core source data table defines a unique identifier for an entity or object. In the reverse index form, every value is simply positioned relative to this unique identifier. Different join scenarios and the manner in which base tables are traversed onto objects are described in the following example join cases and FIGS. 10-11.

Join Case 1—Zero Joins: Title From Objects

One example join operation involves joining the previously described IRFieldGroups 820, IRFields 800, and ISTables 700 tables. The result of run-time queries joining these three tables is presented in table 1000. Table 1000 also serves as a beginning reference point for the other three join operation examples.

Specifically, the resulting table 1000 is based on the common FieldGroup 1002 and Display Name 1004 columns in both the IRFieldGroups 820 and IRFields 800 tables, the corresponding FieldID 1006 and FieldName 1007 based on the common FieldGroupID 820 columns, the common TableID column (replaced with the corresponding TableName 1008 for clarity) of ISTables 710 and IRFields 800, and the common JoinPath 1009 for these entries. To retrieve either the Title or Year values, the JoinPath=0. A zero value for the JoinPath 1009 indicates that no join operations are necessary, and these values can be retrieved from corresponding objects. An example of a query in this instance is as follows:

SELECT <TableName>,<FieldName>, Objects.ObjectID FROM <TableName>, or in this case, SELECT Objects.Title, Objects.ObjectID FROM Objects. In this example, the above query retrieves the requested Title and Year values, and these values are related back to the object identified by ObjectID 302 in the Objects table 300.

Join Case 2—Artist Information

Beginning again with reference to table 1000 and the FieldName column 1007, assume for example, that a request is made for an ArtistName and Artist YearOfBirth. The artist name and year of birth data is included within Artists 400 in ArtistName 404 and DateOfBirth 406 columns. The corresponding FieldID 1006 values are 6 and 7. In this case, FieldNames 1007 ArtistName and YearOfBirth both relate to the artist, not the object. Thus, these two fields can be grouped as a FieldGroup, and specifically, and the field group identified by FieldGroup=6. This particular FieldGroup has a DisplayName 1004 “Artist” instead of the individual labels of ArtistName and YearOfBirth. These fields are eventually associated with an object.

In performing the join operation, the data processing system 112 determines the join paths associated with the grouped fields. In the current case, referring back to ISJoins 900, both fields contain a JoinPath value of “5.” As a result, the data processing system 112 cross references the JoinPath field with the ISJoins table 900 (actually, the ISJoins table 900 joined to the ISTables table 710) The result of this join operation is illustrated as table 1100. Specifically, table 1100 includes columns: JoinID 1102, TableName 1104, StartFieldName 1106, Tables_{—}1.TableName 1107, EndFieldName 1108, and NextJoin 1109.

Performing the join operation of JoinID=5, the table with TableName 1104 “Artists” is joined through the StartFieldName 1106 “ArtistID ” to the EndTableName 1107 “ArtistToObject” via the EndFieldName 1108 “ArtistID.” Thus, the first resulting join operation is represented with the following query:

Artists INNER JOIN ArtistToObject ON Artists.AristsID=ArtistToObject.ArtistID

The result of this join operation, however, does not result in associating fields with an object. Rather, the NextJoin 1109 value is JoinID=6. Since the NextJoin 1109 value is a non-zero value, the join operation represented by JoinID=6 is performed before object associations are achieved.

The join operation identified by JoinID=6 may be represented by the following query:

ArtistToObject INNERJOIN Objects ON ArtistToObject.ObjectID=Objects.ObjectID.

The combination of these two join operations is as follows:

SELECT Artists.ArtistName, Artists.YearOfBirth, Objects.ObjectID

FROM Artists INNER JOIN Objects ON ArtistToObject.ObjectID=Objects.ObjectID

INNER JOIN Artists ON ArtistToObject.ArtistID=Artists.ArtistsID.

The result of these join operations is illustrated in table 1110. Table 1100 includes columns ArtistName 1112, YearOfBirth 1114, and ObjectID 1116. Thus, as requested, the ArtistName 1112 and YearOfBirth 1114 (or DateOfBirth) are associated with an object represented by the unique numeric identifier ObjectID 1116.

Case 3—Four Joins (Project Member From People)

Another example of how join operations are performed to associate data with a particular object is provided. Specifically, four join operations are performed to obtain results associating an object from the table “Objects” 300 with a name from the table “People” 620. An example query retrieving these results is as follows:

SELECT Objects.ObjectID, People.Name

FROM (((Objects INNER JOIN ProjectToObject ON Objects.ObjectID=ProjectToObject.ObjectID INNER JOIN Projects ON ProjectToObject.ProjectID=Projects.ProjectID)

INNER JOIN ProjectMember ON ProjectMember.Project=Projects.ProjectID)

INNER JOIN People ON ProjectMember.Person=People.PeopleID).

Specifically, this query calls to select values in the Object ID column 302 of Objects 300 and values in the Name column 624 of People 620 satisfying the four join operations in the FROM clause. The first join operation in the FROM clause is an INNER JOIN of the Objects 300 and ProjectToObject 650 tables on the ObjectID column 302 and 654 of each of these tables. The results of the first join operation are embodied in a first results table and are applied to the second join operation. The second join operation is an INNER JOIN of the first results table and the Projects table 640 on the ProjectID column 642. The results of the second join operation are embodied in a second results table and are applied to the third join operation. The third join operation is an INNER join of the second results table and the ProjectMember table 630 on the Project column 634 of the ProjectMember table 630 and the ProjectID column 642 of the Projects table 640. The results of the third join operation are embodied in a third results table and are applied to the fourth and final join operation. The fourth join operation is an INNER JOIN of the third results table and the People table 620 on the Person column 632 of the ProjectMember table 630 and the PeopleID column 622 of the People table 620. The results include people represented in the Name column 1134 related to Objects 1132 via projects.

Case 4—Events

A final example of join traversal relates to associating events with objects and locations. Referring back to table 1000 involving the joins of ISTables 710, ISFields 800, and IRFieldGroups 810, a request is made to retrieve data related to events and related object and location data. For the Events field group, the JoinPath 1009 is 7. Thus, with reference to ISJoins 900, JoinID=7, three join operations are performed. More specifically, after the join operation relating to JoinID=7 is performed, the join operation relating to Join ID=8 is performed according to the NextJoin column 909. After the join operation relating to JoinID 8 is performed, the join operation relating to JoinID 9 is performed according to the NextJoin column 909. Finally, the join operation relating to JoinID 9 is performed. The NextJoin 909 value for this JoinID is 0. As a result, no further join operations are required, and the requested data is associated with an object/ObjectID. An example query combining these join operations is as follows:

SELECT Locations.LocationName, Events.Date, Events.Description, Objects.ObjectID FROM ((Events INNER JOIN EventToObject ON Events.EventID=EventToObject.EventID)

INNER JOIN Locations ON Events.LocationID=Locations.LocationID)

INNER JOIN Objects ON EventToObject.ObjectID=Objects.ObjectID.

The results of these join operations is illustrated in table 1140 illustrating desired relationships in the LocationName 1142, Date 1144, Description 1146 and ObjectID 1148 columns.

Having described the mapping tables generated by the data processing system 112, these mapping tables are utilized by the data processing system 112 to transform the source relational database into a set of inverted table structures.

Inverted/Index Tables

Referring back to FIG. 2, continuing with block 220, the data processing system 112 generates inverted tables from the source table content based on the previously described mapping tables. The mapping tables serve as “control relations” that guide the conversion of data in the source tables to the inverted tables. Thus, the inverted table structures contain the atomized information of values, terms, and numeric content of the source tables. In the present invention, the mapping tables and the inverted table structures are the same for any relational database resource or set of source tables.

Structure of Data Within Inverted Tables

Tables of the inverted data structure may include different types of data. For example the inverted data structure may be based on terms or values. A value is the alphabetic or numeric data in a field and may include one or more terms. For example, in the expression Location=“San Francisco”, “San Francisco” is a value whereas the terms include “San” and “Francisco”.

Creating Term Lookup Tables

One aspect of creating inverted tables is creating terms and indexing terms in a manner such that the terms table may eventually be used to locate an object with that term. Initially, in creating inverted tables, the data processing system 112 performs join operations (such as those example operations previously described) to juxtapose the field's value against the ObjectID. In other words, values are presented along side the ObjectID data for reference. For example, table 1200 illustrates a sample source table with columns ArtistName 1202, YearOfBirth 1204, and ObjectID 1206. Within the ArtistName column 1202, the first field entry is “Kandinsky,Vasilly”.

The data processing system 112 searches the DTTerms table 1210 to determine whether the term “kandinsky” already exists and has been accounted for. In this case, this is the first time the term “kandinsky” appears in the source data. Thus, this term is added to the DTTerms table 1210. DTTerms table 1210 includes columns TermID 1212, Keyword 1214, and RefCount 1216. Each keyword 1214 or term is identified with a unique identifier in the TermID column 1212. In this case, TermID=1 corresponds to Keyword=kandinsky. Since this is the first time that this particular term or keyword has been indexed, RefCount 1216 indicates a “1” value to illustrate that this is the first time that “kandinsky” has appeared.

In addition to maintaining a count of term occurrences, the data processing system 112 also maintains associations of each term or keyword with the related object and field reference in the DTTermObjectMap table 1220. The DTTermObjectMap table 1220 includes columns TermID 1222, ObjectID 1224, and FieldID 1226. The table maps the instances of terms relative to objects and the fields from which the term originated. This numeric map allows from extremely efficient term searching.

Continuing with the next term in the ArtistName column 1202 of table 1200, the data processing system 112 indexes the term “vasilly”. Again, since this is the first time the term “vasilly” appears in the source data, the term is added to both the DTTerms table 1210 and referenced in the DTTermObjectMap table 1220 resulting in the DTTerms table 1230 and DTTermObjectMap table 1240 respectively. Thus, the term “vasilly” is the second term under TermID 1232 and 1242, and the RefCount 1236 for this particular keyword is also “1” since this is the first time that this term appears. Similarly, the TermID 1242 of “vasillsy” is associated with a corresponding object/ObjectID 1244 and FieldID 1246.

The next term in the ArtistName column 1202 of table 1200 is “delacroix”, and then “Eugene.” These terms appear for the first time and are added to DTTerms 1230 and DTTermObjectMap 1240 resulting in DTTerms 1250 and DTTermsObjectMap 1260 respectively. Thus far, each of the four terms kandinsky, vasilly, delacroix, and eugene, have appeared once, as indicated by RefCount. Further these terms all related to ObjectID=1.

The next entry in the ArtistName column 1201 of table 1200 is Kandinsky again. This is the second time this term appears. As illustrated in the ObjectID column 1206 of table 1200, this term relates to the object identified by ObjectID=2 rather than ObjectID=1. As a result, the RefCount field 1256 of the DTTerms table 1250 is incremented from 1 to 2. Further, since this term relates to the object identified by ObjectID=2, this relationship is entered in the DTTermObjectMap table 1260. The resulting tables appear as DTTerms 1300 which maintains the previously described TermID 1302, Term 1304, and RefCount 1306 columns, and as DTTermsObjectMap table 1310 which maintains the TermID 1312, ObjectID 1314, and FieldID 1316 columns.

Additionally, if desired, an ISStopList table 1320 may be generated. ISStopList 1320 indicates terms that are not indexed. Examples of these terms are listed in the Term column 1322 of the ISStopList 1320. In this example, common indefinite and definite articles such as “a”, “an” “the” and “of” are not indexed since they are not substantive terms and would not be effective in locating an object.

In summary, term look-up tables are created to provide an inventory of keywords relative to objects. In other words, these tables indicate which objects include a particular term and the fields related to these terms, for whatever database may be utilized whether it relate to art, business, automobiles, etc.

Instead of merely providing for searches on individual terms, and to provide enhanced searching flexibility, the data processing system 112 also enables searches on values with reverse lookup value tables. Reverse lookup value tables are generated similarly to term lookup tables except that entire values rather than specific terms are indexed. Those skilled in the art will recognize that reverse lookup tables with only values, only terms, or a combination of terms and values may be generated.

Creating Value Lookup Tables

The basic process described above with respect to terms is also applicable to values and their related tables. More specifically, for each value, the data processing system 112 determines whether a value is entered in a table, maintains a reference count of how many times the value appears, and maintains the value's relationships to objects. However, unlike DTTerms and DTTermsObjectMap 1300 and 1310, values with different data types (e.g., number, string, hierarchical) are entered and stored separately. Separating different data types in this manner permits the data processing system 112 to process queries with greater-than, less-than, and other Boolean expressions correctly.

Creating Value Lookup Tables—String Values

The generation of reverse lookup value tables is initiated by performing join operations, for example, the join operations and resulting tables 1110 in Case 2, FIG. 11. Resulting table 1110 includes columns ArtistName 1112, YearOfBirth 1114, and ObjectID 1116. Values in this table, as compared to terms, include: “Kandinsky, Vasilly”; “1866”; “Delacroix, Eugene”; and “1798”.

To ensure proper search relations and accurate results, character strings and numeric values types are stored separately. Character strings and numeric values are stored in ValueText and ValueNumber, respectively. The IRFields table specifies the field type for each source data field. These values determine the appropriate column (ValueText or ValueNumber) that values will be inserted into. For this example, both “ArtistName” and “YearofBirth” have a field type value of “1”, indicating that the source content is a string type.

More specifically, for each string value, the data processing system 112 determines if the value is stored in DTValueText table 1400 which includes columns ValueID 1402, ValueText 1404, FieldID 1406, and RefCount 1408. As these values will appear for the first time, each value, identified by ValueID 1402 is entered in the ValueText column 1404 of the DTValues table 1400 with the corresponding FieldID 1406 and RefCount 1408. Thus, RefCount=1. This is similar to the manner in which the data processing system 112 adds each term as a keyword in the DTTerms tables 1210, 1230, and 1250.

Additionally, the relationship of each value is related back to the object in the DTValueTextObjectMap table 1410 with columns ValueID 1412, ObjectID 1414, and Preferred 1419. In DTValueTextObjectMap 1410, each value is associated with a corresponding object through ObjectID 1414. Preferred 1419 values define the primary value for display when multiple values for the same field appear within the result set.

Creating Value Lookup Tables—Numeric Values

As another example of creating reverse lookup values, a different assumption may be made that the ArtistName 1112 values are string values and YearOfBirth 1114 values are numeric values. As a result, the data processing system 112 utilizes two columns to store the different values.

More specifically, string values are stored in DTValueText table 1420, and numeric values are stored in DTValueNumber table 1430. Each of these tables 1420 and 1430 includes Value ID 1422/1432, ValueText 1424/1434, ValueNumber 1426/1436, FieldID 1428/1438, and RefCount 1429/1439. However, string values (ValueID=1 and 3) are stored in the ValueText column 1424 of DTValueNumber 1420 whereas numeric values (ValueID=2 and 4) are stored in the ValueNumber 1436 column of DTValueNumber 1430. Thus, for each string value, the Value Number column 1426 of DTValueText 1420 is not used, and for each numeric value, the ValueText column 1434 of DTValueNumber 1430 is not used.

Those skilled in the art will recognize that values with different formats or different combinations of formats may be represented in tables relating to terms, relating to values, and relating to a combination of terms and values, whether those values are string, numeric, or other data types.

Mapping Standards

Referring back to FIG. 2, block 230, having created the inverted tables, the data processing system 112 reconciles different data classifications using international or specialized data standards. In other words, in block 230, the data processing system 112 maps fields in the source tables to the international or specialized standards (using, for example, StandardLookUp, StandardFields, StandardFieldRelations, and StandardStartup tables). The data processing system's 112 meta data standard support reconciles semantic and field granularity issues which arise when searching across multiple heterogeneous data sets. A source database's native field set is mapped to a detailed mapping standard. To compensate for field granularity issues between data sets, the data processing system 112 supports the mapping of multiple native fields to a single standard field, or visa versa.

For example, one data set provides three fields to describe creator attributes; 1) Name, 2) Life Dates, and 3) Nationality. Another data set that is a published standard, contains similar information about the creator, but only in one field, Creator. With the data processing system 112, the three fields from the first data set are mapped to a single field in the second data set. Standards mapping resolves structural and semantic conflicts when searching across data sets. After the desired objects are identified, field names for values across data sets differ from those used organize or classify native object data.

The data processing system 112 addresses this problem by utilizing metadata standards. The metadata standards serve as a bridge between query fields and object fields. With these metadata bridges, the data processing system 112 ensures that the meaning of the data classification system is clear and that all requested data is retrieved. Thus, the metadata standards address the concerns of consistent searching across different collections, the common fields of multiple collections, which fields can be used to search all or several collections at the same time, and which fields are unique to collections. Examples of how meta data standards align collection fields with local, specialized, and published descriptive standards are described below.

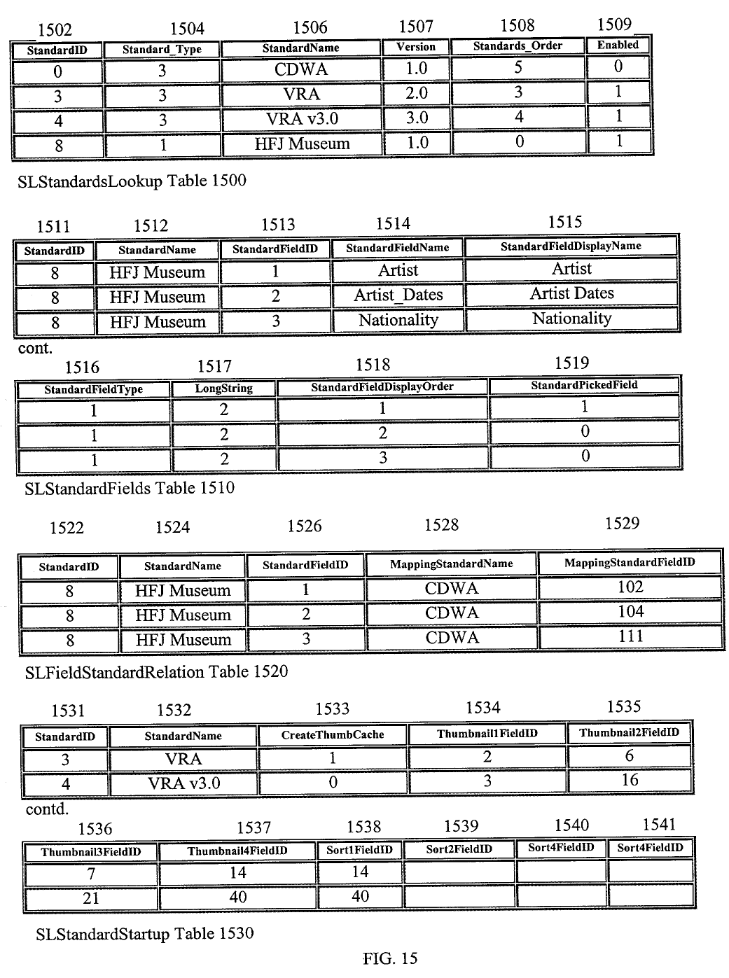

With reference to FIG. 15, the data processing system 112 uses the SLStandardsLookup table 1500 to define the characteristics of each metadata standard. The SLStandardsLookup table includes columns StandardID 1502, StandardType 1504, StandardName 1506, Version 1507, Standards Order 1508, and Enabled 1509. StandardID 1502 is a unique identifier assigned to a particular mapping standard. The StandardType 1504 refers to the type of standard recognized by the data processing system 112. Specifically, StandardType=1 refers to a native field set, StandardType=2 refers to an institutional standard, and StandardType=3 refers to a Published standard. Further, the Standard Name 1506 and Standard Version 1507 may be indicated. Additionally, Standard Order 1508 indicates a preferred display order of standards. For example, different collections may be represented more effectively with different descriptive standards. Thus, one collection may prefer standard 1 and another collection may prefer standard 2. The standard preferences may be represented in an order. If the data processing system 112 attempts to open multiple collections, some of which have different standard preferences, these differences are reconciled by selecting the most common preferred standard. Thus, the data processing system 112 then maps the collection fields to other metadata standards, such as VRA, CIMI, Dublin Core, and USMARC using a mapping standard, such as CDWA, as a bridge

For each of the standards in the StandardsLookup table 1500, the SLStandardFields table 1510 lists the fields of that standard. The SLStandardFields table includes columns StandardID 1511, StandardName 1512, StandardFieldID 1513, StandardFieldName 1514, StandardFieldDisplayName 1515, StandardFieldType 1516, LongString 1517, StandardFieldDisplayOrder 1518, and StandardPickedField 1519. The StandardID 1511, as previously explained, is a unique numeric identifier assigned to a standard entry in the SLStandardsLookup table 1500. The StandardName 1512 is the name assigned to the standard as found in the SLStandardsLookup table 1500. The StandardFieldID 1513 is a numeric identifier for a standard or collection field. In one embodiment of the present invention, collection field entries are identical to the values in the IRFields table 800.

The StandardFieldName 1514 is the name of the data field as it appears in the descriptive data table. For standard fields, this field provides a reference to the standard's unedited field names. In the event that a different field name is to be used as a display name, this display name is provided in StandardFieldDisplayName 1515. The StandardFieldType 1516 denotes the data type of a field. For example, StandardFieldType=1 denotes a text value and a StandardFieldType=2 denotes a numeric value. LongString 1517 determines a field's data layout within the client's 102 data window. For example, LongString=0 indicates that data is wrapped to the center of the window, and a toggle is presented if data is longer than one line. LongString=1 indicates a long text string and that data is wrapped to the left. LongString=2 indicates that data is wrapped to the center and that all data is represented. The StandardFieldDisplayOrder column 1518 denotes the display order of data fields by the data processing system 112. Finally, the StandardPickedField 1519 specifies whether or not the field should be elevated to an immediate search field.

As an example, the SLStandardFields table 1510 lists the fields and field attributes for the HFJ Museum standard (StandardID=8). For each of these fields, columns 1515-1519 indicate the field attributes previously described.

With the SLFieldStandardRelation table 1520, the data processing system 112 maps each standard and collection field to an intermediate mapping standard field. The SLFieldStandardRelation table 1520 includes columns StandardID 1522, StandardName 1524, StandardFieldID 1526, MappingStandardName 1528, and MappingStandardFieldID 1529. The StandardID 1522 is the unique numeric identifier assigned to a standard entry in the SLStandardsLookup table 1500. The StandardName 1524 is the name assigned to the standard as found in the SLStandardsLookup table 1500. The StandardFieldID 1526 is the StandardFieldID 1513 from the SLStandardsFields table 1510 to be mapped. The MappingStandardName 1528 is the name of the mapping standard. The MappingStandardFieldID 1529 is the StandardFieldID 1513 from SLStandardFields 1510 that belongs to the mapping standard.

Each field listed in SLStandardFields 1520 should have a mapping standard equivalent. The data processing system 112 supports the mapping of multiple collection fields to one mapping standard field, or visa versa.

Having mapped the collection fields against a detailed mapping standard, in block 230, the data processing system 112 maps the database fields to metadata standards using the mapping standard. The metadata standards may then be utilized to search and retrieve data for objects. Another table for metadata standard support and cross collection searching is SLStandardLookup 1530. This table defines the default thumbnail and sort fields for each listed standard. During the client start-up process, the application servers agree upon a common standard, then based on that standard, the content appears in the order specified by SLStandardStartup. The SLStandardsStartup table 1530 includes columns: StandardID 1531, StandardName 1532, CreateThumbCache 1533, Thumbnail1FieldID 1534, Thumbnail2FieldID 1535, Thumbnail3FieldID 1536, Thumbnail4FieldID 1537, Sort1FieldID 1538, Sort2FieldID 1539, Sort3FieldID 1540, and Sort4FieldID 1541. StandardID 1531 is the unique numeric identifier assigned to a standard entry in the SLStandardsLookup table 1500. The StandardName 1532 is the name assigned to the standard as found in the SLStandardsLookup table 1500. The CreateThumbCache column 1533 indicates whether a thumbnail cache should be created on start-up. The Thumbnail Fields 1534-1537 represents the StandardFieldID 1513 from SLStandardFields 1510 to be displayed in a thumbnail. The Sort Fields 1538-1541 are the StandardFieldID 1513 from SLStandardFields 1510 to be used for sorting.

With these metadata standards, the meaning of collection fields can be interpreted across collections such that the query with different field classifications will retrieve all the necessary data using the metadata standards. The technology also supports “local” standards that may be electively defined and chosen by information resource owners. Each information resource can have an order of preference in which standards are applied for searching.

Query, Native Fields That Map To Collection Fields, And Identifying Objects

With the meta standards in place, different data sources may be consistently and simultaneously searched even if a query requests data in a different classification scheme than the data source.

Referring back to FIG. 2, block 240, the data processing system 112 receives a query requesting data relating to an entity, such as an object or table, in the database.

In response to the query, in block 250, the data processing system identifies native collection fields that map to a standard field searched. For example, assume that the active or default standard is the Dublin Core. If the query requests data in the field “Artist”, this field is mapped to the Dublin Core field “Creator”. Similarly, if the query involves the native field “Year”, this native field is mapped to the Dublin Core field “Date.”

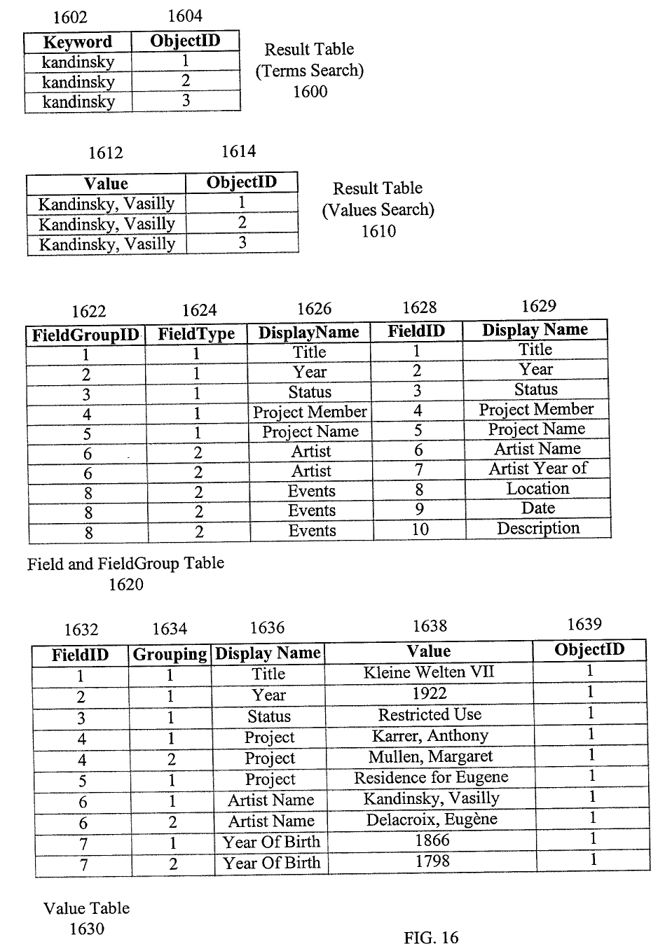

Then, in block 260, the data processing system 112 identifies which objects satisfy the query's search criteria. More specifically, the data processing system 112, based on the query and standard fields that may incorporate one or more database fields, identifies which objects satisfy the query search criteria. The meta standards resolve differences between native database fields of the query and fields used to organize and store the data. The object identification process is further explained with reference to FIG. 16.

Identifying Objects Using Terms Searching

With the data processing system 112 incorporated into the various databases, the data processing system 112 submits a term or value search query. For example, a sample term search query that requests all objects that use the term “Kandinsky” would be:

SELECT DTTerms.Keyword, DTTermObjectMap.ObjectID

FROM DTTerms INNER JOIN DTTermObjectMap ON

DTTerms.TermID=DTTermObjectMap.TermID

WHERE (((DTTerms.Keyword)=“kandinsky”)).

The results of this query are illustrated in table 1600. Table 1600 includes columns Keyword 1602 and ObjectID 1604. Table 1600 provides that the term or keyword 1602 “kandinsky” relates to three objects—objects identified by ObjectID=1, ObjectID=2, and ObjectID=3. Multiple search terms may be entered to narrow a result set using implied Boolean logic. Implied Boolean logic refers to a search in which symbols are used to represent Boolean logical operators. In this type of search, the absence of a symbol is also significant, as the space between keywords defaults to AND logic. Also, the data processing system 112 provides wildcard support. Asterisks “*” function as string wildcards and question marks “?” serve as character wildcards. For example, if a user wishes to locate objects related to photography, “photo*” may be used as a search term to broaden the result set. This search criterion brings back objects relating to photograph, photography, photos, photographer, etc.

Identifying Objects Using Value Searching

The data processing system 112 may also locate a list of objects using searches based on field values. Alternatively, a search for a particular entity may be performed to identify related objects. One example of a search for objects with a particular value ArtistName=“kandinsky, vasilly” would be:

SELECT DTValues.ValueText, DTValueToObject.ObjectID

FROM DTValues INNER JOIN DTValueToObject ON DTValues.ValueID=DTValueToObject.ValueID

WHERE (((DTValues.ValueText)=“kandinsky, vasilly”) AND

(DTValues.Field=6)).

The results of this query are illustrated in table 1610. Table 1610 includes columns Value 1612 and ObjectID 1614. Table 1610 displays the value “kandinsky, vasilly” relative to three objects. These objects are identified by ObjectID=1, ObjectID=2, and ObjectID=3. It is possible to compose some complex search expressions using Boolean logic on this data processing system. To do so, Boolean operators may be used with multiple search relations and criteria. For instance, if a user wishes to locate objects by “kandinsky, vasilly” AND was produced in 1922.

SELECT DTValues.ValueText, DTValueToObject.ObjectID

FROM DTValues INNER JOIN DTValueToObject ON DTValues.ValueID=DTValueToObject.ValueID

WHERE (((DTValues.ValueText)=“kandinsky, vasilly”) AND (DTValues.Field=6)). AND (((DTValues.ValueNumber)=1922) AND (DTValues.Field=2)).

After identifying objects with a terms search, values search, or combination thereof, the data processing system 112 retrieves data from these objects.

Retrieving Data From Identified Objects

Referring back to FIG. 2, block 270, the data processing system submits a query to the identified objects and retrieves values from the identified objects, i.e., the object matching the search criteria. The query may request data from one database, from multiple databases, from multiple distributed databases, and databases storing data in different standards since the metadata standards will reconcile those standards into a common standard. The retrieval process will be explained in further detail below.

First, a query retrieves fields and field groups such that values may be obtained based on these fields and field groups. For example, table 1620 illustrates the requested fields and field groups. Specifically, table 1620 includes columns FieldGroupID 1622, FieldType 1624, DisplayName (FieldGroupID) 1626, FieldID 1628, and Display Name (FieldID) 1629. The FieldGroupID 1622 is a unique identifier for each Field Group or groups of individual related fields. The FieldType 1624 indicates what whether the field entries are string or numeric values. DisplayName 1626 is the display name for the field group. FieldID 1628 is a unique identifier for an individual field, and DisplayName 1629 is the display name for individual fields.

Second, the values are retrieved for the objects. In this example, assume that data values are retrieved from one object. Of course, data values may be retrieved from various databases for numerous objects as was previously described. In order to retrieve the descriptive data for an object, a query requests all values for a particular ObjectID as well as a reference to the field the values describes. Thus, for the object identified by ObjectID=1, the result maybe Example1 table 1630. Example1 table 1630 includes columns: FieldID 1632, Grouping 1634, DisplayName 1636, Value 1638, and ObjectID 1639. Each value 1638 retrieved from the object identified by ObjectID=1. In this example, since only one object was used, referring back to the Objects table 300, this object is the Kleine Welten VII object. Each value 1638 relates to this object. For example, this work of art was created in 1922, has a restricted use status, was created by both Vasilly Kandinsky and Eugene Delacroix who were born in 1866 and 1798 respectively. Thus, depending on the values requested in the query, many different types of information can be retrieved.

Formatting Retrieved Values

Referring back to FIG. 2, block 280, having retrieved the values from the objects, whether stored on a single database, multiple databases, distributed databases, or in different classification schemas, the values may be formatted for display. To format the display, the data processing system 112 references the configuration columns located in IRFieldGroups and IRFields. Thus, for example, the formatted display may appear as follows:

| | | | | |
|---|---|---|---|---|
| | Title: | Kleine Welten VII | | |
| Field Group → | Artist | | | |
| Artist entity field group | | Name: Kandinsky, Vasilly | | |
| consisting of “Name” and “Year | | Year Of Birth: 1866 | | |
| of Birth.” The Preferred value, | | Name: Delacroix, Eugéne | | |
| Kandinsky, appears first. | | Year Of Birth: 1798 | | |
| | Year: | 1922 | | |
| | Status: | Restricted use | | |
| Repeating Values → | Medium: | Oil, Canvas, Wood | | |
| Separate repeating values using | Event | | ← | Field Group |
| commas, semi-colons, or place | | Modernistic Conceptions | | Event entity field group |
| each value on a new line. | | Dalton Museum of Art | | consisting of “Event Name,” |
| | | 1984 | | “Location,” and “Date.” |
| | Projects: | Residence for Eugene Ray- | | Individual field names have |
| | ford | | | |

To further enhance the display of the retrieved values, field groups may be configured such that information relating to a single person, event, work of art, etc. is grouped together. For example, with the following display format, the artist names are not matched with the artist date of birth:

Artist Name 1

Artist Name 2

Artist Name 3

ArtistName 4

DateOfBirth 1

DateOfBirth 2

DateOfBirth 3

DateOfBirth 4

The values become more removed from their groups as more fields are displayed and as more values are displayed. Systems typically represent repeating values in the above nature. Instead, the data processing system 112 may organize field groups such that the related values are grouped and displayed together. For example, field grouping may be utilized to present information related to a single artist:

ArtistName: Kandinsky, Vasilly

DateOfBirth: 1866

Alternatively, field grouping may be used to present information related to multiple artists. In this example, the information for each artist is grouped together:

ArtistName: Kandinsky, Vasilly

Year: 1866

ArtistName: Delacroix, Eugene

Year: 1798

Further, field grouping may be utilized to display only the actual value data rather than the display names:

Kandinsky, Vasilly

1866

Delacroix, Eugene

1798

With these three examples, the related values are grouped together such that a user can quickly identify all of the related information.

Additionally, the order in which the values are displayed may be specified in a preference specification. For example, if the retrieved values relate to ten different artists, a preferred field may indicate the order in which the artist information should be displayed. The preferences may also be combined with the grouping previously described such that groups of artist information are specified to be displayed in a preferred order or sequence. After formatting has been completed, the values are displayed to a user in block 290.

Example Search

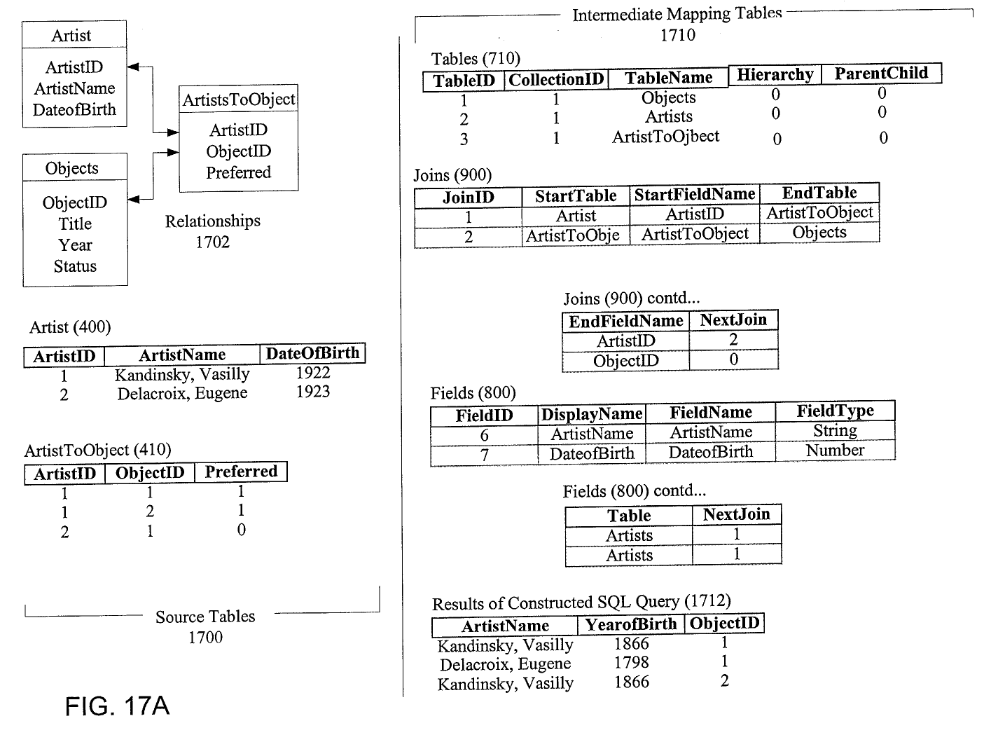

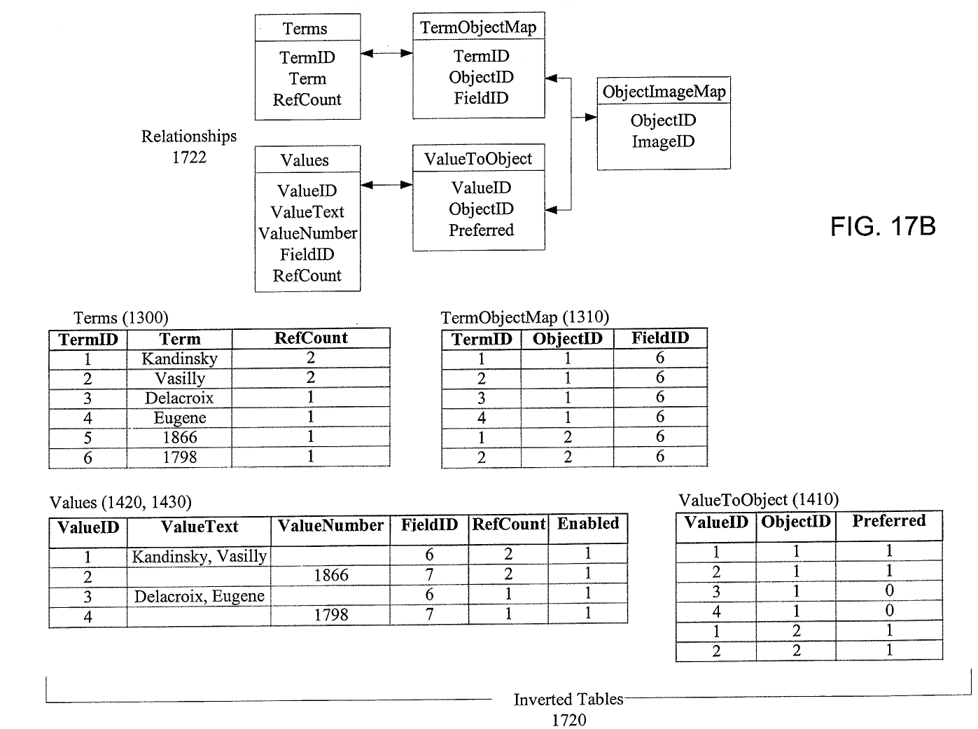

FIGS. 17A-B bring together the previously described concepts with a simple search example and illustrate that relationships embodied in source tables 1700 are represented by the combination of the mapping tables 1710 and inverted or index tables 1720, i.e., source tables 1700=mapping tables 1710+inverted tables 1720.

As illustrated in FIG. 17A, source tables 1700 relate to objects through relationships 1702 of between unique identifiers ArtistID and ObjectID. In this particular example, the source tables previously described are simplified to include information on only two artists. A simplified “Artists” table (400) includes information about Vasilly Kandinsky and Eugene Deloacroix, and a simplified “ArtistToObject” table (410) illustrates the relationships between each artist and related objects.

Similarly, simplified generated mapping tables 1710, which are generated as explained with respect to FIGS. 7-11, are also provided. Again, the mapping tables in this example are simplified forms of “Tables” (700), “Fields” (800), and “Joins” (900).

An example constructed query based on these mapping tables is as follows:

SELECT Artists.ArtistName, Artists.DateOfBirth, Objects.ObjectID

FROM Artists INNER JOIN

ArtistToObject ON

Artists.ArtistID=ArtistToObject.ArtistID INNER JOIN

Objects ON

ArtistsToObject.ObjectID Objects.ObjectID.\

The results of this query are provided in the Results of Constructed SQL Query table 1712. This table associates each artist name with a corresponding year of birth and object.

With reference to FIG. 17B, based on the content of source tables 1700, inverted tables 1720 are generated by the data processing system 112 based on the generated mapping tables. Similarly, for this particular example, the simplified inverted tables are based on “Terms” (1300), “TermObjectMap” (1310), “Values” tables (1420 and 1430), and “ValueToObject” (1410) tables. The relationships 1722 between various inverted tables are illustrated.

Having generated the mapping tables and inverted tables, assume, for example, that a query requests an object, table, or other data with the following criterion:

Artist=Kandinsky, Vasilly And

Year=1922

Further assume that the active standard is the Dublin Core. Indeed, those skilled in the art will recognize that numerous other standards may be utilized. Having established the query criterion, data fields that map to Dublin Core standard fields are identified. In this example, the native database field “Artist” maps to the Dublin Core field “Creator.” Similarly, the native database field “Year” maps to the Dublin Core field “Date.”

Having mapped the database fields to the Dublin Core, a query is issued to locate or identify objects with the requested query criterion. An example query might be as follows:

SELECT DTValueToObject.ObjectID

FROM DTValues.DtValueToObject

WHERE (DTValues.ValueID=DTValueToObject.ValueID) AND (((DTValues.FieldID=2)) AND

((DTValues.ValueText LIKE‘Kandinsky, Vasilly’)))

AND (((DTValues.FieldID=7)) AND

((DTValues.ValueText LIKE ‘1922’)))

Having identified which objects involve the query criterion, the data processing system 112 retrieves values from the database for the identified objects with the following example query:

SELECT IRFields.FieldID, ObjectID,

DTValues.ValueText, Values.ValueNumber”.

Thus, FIGS. 17A-B illustrate that any set of structured source tables may be represented as a set of mapping tables and inverted or index tables. FIGS. 17A-B further illustrate how a request for data is satisfied by mapping database fields to standard fields, and in response to a query for object or table data, identifying objects satisfying the query utilizing the mapped standard fields and retrieving the requested data.

### Conclusion

Based on the forgoing, the data processing system 112 enhances the ability to search for and retrieve data from objects that may be stored in various databases and in various data formats. The data processing system 112 supports searches of various types of data using meta-standards, and these searches may be performed on a single database, multiple databases, distributed databases. Applied on a large scale, the data processing system 112 enables widespread simultaneous searching of multiple, distributed databases resulting in access to large amounts of data.

Those skilled in the art will recognize that the present invention may be implemented in many other data search and retrieval applications than the one application described related to distributed, heterogeneous data sets describing works of art. For example, the data processing system 112 may be utilized with databases related to different topics such that the source tables relate to business (cost, price, customer, customer location, shipping date, receive date), automotive (make, model, trim, dealer, dealer location, port of entry, etc.), and various other topics. As a result, the mapping tables and inverted tables will reflect this different data. Further, the data processing system 112 may be utilized with a single data set or with multiple data sets. For example, some searches may require data from only one database whereas other searches may require data from multiple databases. Additionally, multiple data sets maybe heterogeneous or homogeneous. Moreover, the present invention may be utilized with multiple data sets that are stored within the same database, within different databases of the same server, or within different databases on different servers. Thus, the databases may or may not be distributed. Indeed, those skilled in the art will recognize that the present invention has broad applications and is not limited to the example application described.

This concludes the description of some embodiments of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the embodiments of the invention has been presented for the purposes of illustration and description. They are not intended to be exhaustive or to limit the invention to the precise form disclosed. Many modifications and variations are possible in light of the above teaching. It is intended that the scope of the invention be limited not by this detailed description, but rather by the claims appended hereto.

We claim:

1. A method of processing data in one or more databases of a database system, the method comprising:
receiving one or more source tables, wherein the source tables describe one or more objects in the database;
generating one or more mapping tables, wherein the mapping tables describe the content and relationships of the source tables;
generating one or more inverted tables from the content and relationships of the source tables, wherein the inverted tables are based on the generated mapping tables; and
mapping fields of the source tables to a predefined related set of fields.

2. The method of claim 1, wherein the predefined related set of fields comprises an international standard.

3. The method of claim 1, wherein the predefined related set of fields comprises a specialized standard.

4. The method of claim 1, further comprising incrementally updating the inverted tables based on new source table data.

5. The method of claim 1, further comprising receiving a query requesting an entity from one or more of the databases, wherein the query requests data with one or more fields of the predefined related set of fields.

6. The method of claim 5, wherein the database entity comprises an object.

7. The method of claim 5, wherein the database entity comprises a table.

8. The method of claim 5, further comprising identifying the database fields that map to the fields of the predefined related set of fields searched.

9. The method of claim 8, further comprising identifying one or more objects satisfying the query.

10. The method of claim 9, further comprising retrieving the object data from each database.

11. The method of claim 10, further comprising formatting the retrieved object data.

12. The method of claim 11, further comprising displaying the retrieved object data in the database field structure.

13. The method of claim 11, further comprising displaying the retrieved object data in a structure of the predefined related set of fields.

14. The method of claim 1, wherein the source tables describe a single database.

15. The method of claim 1, wherein the source tables describe multiple databases.

16. The method of claim 15, wherein the source tables describe heterogeneous databases.

17. The method of claim 15, further comprising receiving a query requesting one or more entities from a plurality of databases, wherein the query is based on one or more fields of the predefined related set of fields.

18. The method of claim 17, further comprising identifying fields of the plurality of databases that map to the fields of the predefined related set of fields searched.

19. The method of claim 18, further comprising identifying one or more objects satisfying the query of the plurality of databases.

20. The method of claim 19, further comprising retrieving the object data from one or more databases of the plurality of databases.

21. The method of claim 17, wherein the query is based on a plurality of fields of the predefined related set of fields.

22. The method of claim 21, further comprising identifying fields of the plurality of databases that map to the plurality of fields of the predefined related set of fields searched.

23. The method of claim 22, further comprising identifying one or more objects satisfying the query of the plurality of databases.

24. The method of claim 23, further comprising retrieving the object data from one or more databases of the plurality of databases.

25. The method of claim 1, wherein the source tables describe distributed databases.

26. The method of claim 1, wherein the source tables are represented by a combination of the mapping tables and the inverted tables.

27. The method of claim 1, wherein object data is simultaneously retrieved from different databases.

28. The method of claim 1, wherein the source tables comprise a relational database.

29. The method of claim 1, wherein the source table platform is XML.

30. The method of claim 1, wherein the source table platform is SGML.

31. The method of claim 1, wherein the inverted table comprises a terms look up table, and wherein the terms look up table is used to identify objects in the database.

32. The method of claim 31, wherein the terms lookup table associates individual terms with objects.

33. The method of claim 1, wherein the inverted table comprises a value lookup table.

34. The method of claim 33, wherein a value in the value lookup table comprises one or more terms.

35. The method of claim 33, wherein the value lookup table associates values with objects.

36. The method of claim 33, wherein values of different data types are stored in separate fields of the value lookup table.

37. A system for processing data in one or more databases of a database system, comprising: one or more computers having a data store coupled thereto, wherein the data store stores data; and one or more computer programs, performed by the one or more computers, for processing data in one or more databases of a database system, wherein the one or more computers are programmed to receive one or more source tables, wherein the one or more source tables describe one or more objects in the one or more databases; generate one or more mapping tables, wherein the one or more mapping tables describe the content and relationships of the one or more source tables; generate one or more inverted tables from the content and relationships of the one or more source tables, wherein the one or more inverted tables are based on the one or more generated mapping tables; and map one or more fields of the one or more source tables to a predefined related set of fields.

38. The system of claim 37, wherein the predefined related set of fields comprises an international standard.

39. The system of claim 37, wherein the predefined related set of fields comprises a specialized standard.

40. The system of claim 37, wherein the one or more computers are programmed further to incrementally update the one or more inverted tables based on new source table data.

41. The system of claim 37, wherein the one or more computers are programmed further to receive a query requesting an entity from one or more of the databases, wherein the query requests data with one or more fields of the predefined related set of fields.

42. The system of claim 41, wherein the database entity comprises an object.

43. The system of claim 41, wherein the database entity comprises a table.

44. The system of claim 41, wherein the one or more computers are programmed further to identify the database fields that map to the one or more fields of the predefined related set of fields searched.

45. The system of claim 44, wherein the one or more computers are programmed further to identify one or more objects satisfying the query.

46. The system of claim 45, wherein the one or more computers are programmed further to retrieve the object data from each database.

47. The system of claim 46, wherein the one or more computers are programmed further to format the retrieved object data.

48. The system of claim 47, wherein the one or more computers are programmed further to display the retrieved object data in the database field structure.

49. The system of claim 47, wherein the one or more computers are programmed further to display the retrieved object data in a structure of the predefined related set of fields.

50. The system of claim 37, wherein the one or more source tables describe a single database.

51. The system of claim 37, wherein the one or more source tables describe multiple databases.

52. The system of claim 51, wherein the one or more source tables describe heterogeneous databases.

53. The system of claim 51, wherein the one or more computers are programmed further to receive a query requesting one or more entities from a plurality of databases, wherein the query is based on one or more fields of the predefined related set of fields.

54. The system of claim 53, wherein the one or more computers are programmed further to identify one or more fields of the plurality of databases that map to the one or more fields of the predefined related set of fields searched.

55. The system of claim 54, wherein the one or more computers are programmed further to identify one or more objects satisfying the query of the plurality of databases.

56. The system of claim 55, wherein the one or more computers are programmed further to retrieve the object data from one or more databases of the plurality of databases.

57. The system of claim 53, wherein the query is based on a plurality of fields of the predefined related set of fields.

58. The system of claim 57, wherein the one or more computers are programmed further to identify fields of the plurality of databases that map to the plurality of fields of the predefined related set of fields searched.

59. The system of claim 58, wherein the one or more computers are programmed further to identify one or more objects satisfying the query of the plurality of databases.

60. The system of claim 59, wherein the one or more computers are programmed further to retrieve the object data from one or more databases of the plurality of databases.

61. The system of claim 37, wherein the source tables describe distributed databases.

62. The system of claim 37, wherein the source tables are represented by a combination of the mapping tables and the inverted tables.

63. The system of claim 37, wherein object data is simultaneously retrieved from different databases.

64. The system of claim 37, wherein the source tables comprise a relational database.

65. The system of claim 37, wherein the source table platform is XML.

66. The system of claim 37, wherein the source table platform is SGML.

67. The system of claim 37, wherein the inverted table comprises a terms look up table, and wherein the terms look up table is used to identify objects in the database.

68. The system of claim 67, wherein the terms lookup table associates individual terms with objects.

69. The system of claim 37, wherein the inverted table comprises a value lookup table.

70. The system of claim 69 wherein a value in the value lookup table comprises one or more terms.

71. The system of claim 70, wherein the value lookup table associates values with objects.

72. The system of claim 71, wherein values of different data types are stored in separate fields of the value lookup table.

73. A system for processing data in one or more databases of a database system, comprising:
one or more computers;
one or more computer programs, performed by the one or more computers, for processing data in one or more databases of a database system;
one or more source tables stored on the one or more computers, wherein the one or more source tables describe one or more objects in the one or more databases;
one or more mapping tables stored on the one or more computers, wherein the one or more mapping tables describe the content and relationships of the one or more source tables;
one or more inverted tables stored on the one or more computers, wherein the one or more inverted tables are generated from the content and relationships of the one or more source tables, wherein the one or more inverted tables are based on the one or more generated mapping tables; and
a predefined related set of fields stored on the one or more computers, wherein one or more fields of the one or more source tables are mapped to one or more fields of the predefined related set of fields.

74. The system of claim 73, wherein the one or more computers are programmed further to receive a query requesting an entity from the one or more of the databases, wherein the query requests data with one or more fields of the predefined related set of fields.

75. The system of claim 74, wherein the one or more computers are programmed further to identify the database fields that map to fields of the predefined related set of fields searched.

76. The system of claim 75, wherein the one or more computers are programmed further to identify one or more objects satisfying the query.

77. The system of claim 76, wherein the one or more computers are programmed further to retrieve the object data from each database.

78. The system of claim 77, wherein the one or more computers are programmed further to format the retrieved object data.

79. The system of claim 78, wherein the one or more computers are programmed further to display the retrieved object data in the database field structure.

80. The system of claim 78, wherein the one or more computers are programmed further to display the retrieved object data in a structure of the predefined related set of fields.

81. The system of claim 73, wherein the one or more computers are programmed further to receive a query requesting one or more entities from a plurality of databases, wherein the query is based on one or more fields of the predefined related set of fields.

82. The system of claim 81, wherein the one or more computers are programmed further to identify fields of the plurality of databases that map to the fields of the predefined related set of fields searched.

83. The system of claim 82, wherein the one or more computers are programmed further to identify one or more objects satisfying the query of the plurality of databases.

84. The system of claim 83, wherein the one or more computers are programmed further to retrieve the object data from one or more databases of the plurality of databases.

85. The system of claim 81, wherein the query is based on a plurality of fields of the predefined related set of fields.

86. The method of claim 85, wherein the one or more computers are programmed further to identify fields of the plurality of databases that map to the plurality of fields of the predefined related set of fields searched.

87. The method of claim 86, wherein the one or more computers are programmed further to identify one or more objects satisfying the query of the plurality of databases.

88. The method of claim 87, wherein the one or more computers are programmed further to retrieve the object data from one or more databases of the plurality of databases.
